(19) United States
(12) Patent Application Publication
(10) Pub. No.: US 2026/0206071 A1
(43) Pub. Date: Jul. 16, 2026

(54) DEDICATED RADIO BEARER FOR PROTOCOL DATA UNIT SESSION

(71) Applicant: QUALCOMM Incorporated, San Diego, CA (US)

(72) Inventors: Juan ZHANG, San Diego, CA (US); Ajith Tom PAYYAPPILLY, San Diego, CA (US); Sitaramanjaneyulu KANAMARLAPUDI, San Diego, CA (US)

(21) Appl. No.: 19/016,663

(22) Filed: Jan. 10, 2025

(51) Int. Cl. H04W 76/10; H04L 67/141; H04W 28/02

(52) U.S. Cl. CPC H04W 76/10; H04L 67/141; H04W 28/0268

(57) ABSTRACT

Various aspects of the present disclosure generally relate to wireless communication. In some aspects, a first network entity may transmit a first communication for establishment of a protocol data unit (PDU) session. The first network entity may receive, based on the first communication, first configuration information for a first radio bearer for the PDU session. The first network entity may receive, based on the first communication, second configuration information for a second radio bearer for the PDU session, wherein the second configuration information indicates a filter state of the second radio bearer. The first network entity may transmit a second communication, wherein the second communication is associated with the PDU session, and wherein the second communication is associated with the second radio bearer based on a second filter state and one or more traffic parameters of the second communication. Numerous other aspects are described.

### FIELD OF THE DISCLOSURE

Aspects of the present disclosure generally relate to wireless communication and specifically relate to techniques, apparatuses, and methods associated with a dedicated radio bearer for a protocol data unit session.

### INTRODUCTION

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mm Wave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

In some aspects, a first network entity includes a processing system configured to: transmit a first communication for establishment of a protocol data unit (PDU) session; receive, based on the first communication, first configuration information for a first radio bearer for the PDU session; receive, based on the first communication, second configuration information for a second radio bearer for the PDU session, wherein the second configuration information indicates a filter state of the second radio bearer, wherein the filter state indicates that first filter information is configured for the second radio bearer or that no filters are configured for the second radio bearer; and transmit a second communication, wherein the second communication is associated with the PDU session, and wherein the second communication is associated with the second radio bearer based on second filter information and one or more traffic parameters of the second communication.

In some aspects, a first network entity includes a processing system configured to: receive a first communication for establishment of a PDU session for a second network entity; transmit, based on the first communication, first configuration information for a first radio bearer for the PDU session; and transmit, based on the first communication, second configuration information for a second radio bearer for the PDU session based on the second network entity being configured to support multiple radio bearers.

In some aspects, a method of wireless communication performed by a first network entity includes transmitting a first communication for establishment of a PDU session; receiving, based on the first communication, first configuration information for a first radio bearer for the PDU session; receiving, based on the first communication, second configuration information for a second radio bearer for the PDU session, wherein the second configuration information indicates a filter state of the second radio bearer, wherein the filter state indicates that first filter information is configured for the second radio bearer or that no filters are configured for the second radio bearer; and transmitting a second communication, wherein the second communication is associated with the PDU session, and wherein the second communication is associated with the second radio bearer based on second filter information and one or more traffic parameters of the second communication.

In some aspects, a method of wireless communication performed by a first network entity includes receiving a first communication for establishment of a PDU session for a second network entity; transmitting, based on the first communication, first configuration information for a first radio bearer for the PDU session; and transmitting, based on the first communication, second configuration information for a second radio bearer for the PDU session based on the second network entity being configured to support multiple radio bearers.

In some aspects, a non-transitory computer-readable medium has code stored thereon that, when executed by a first network entity, causes the first network entity to: transmit a first communication for establishment of a PDU session; receive, based on the first communication, first configuration information for a first radio bearer for the PDU session; receive, based on the first communication, second configuration information for a second radio bearer for the PDU session, wherein the second configuration information indicates a filter state of the second radio bearer, wherein the filter state indicates that first filter information is configured for the second radio bearer or that no filters are configured for the second radio bearer; and transmit a second communication, wherein the second communication is associated with the PDU session, and wherein the second communication is associated with the second radio bearer based on second filter information and one or more traffic parameters of the second communication.

In some aspects, a non-transitory computer-readable medium has code stored thereon that, when executed by a first network entity, causes the first network entity to: receive a first communication for establishment of a PDU session for a second network entity; transmit, based on the first communication, first configuration information for a first radio bearer for the PDU session; and transmit, based on the first communication, second configuration information for a second radio bearer for the PDU session based on the second network entity being configured to support multiple radio bearers.

In some aspects, an apparatus for wireless communication includes means for transmitting a first communication for establishment of a PDU session; means for receiving, based on the first communication, first configuration information for a first radio bearer for the PDU session; means for receiving, based on the first communication, second configuration information for a second radio bearer for the PDU session, wherein the second configuration information indicates a filter state of the second radio bearer, wherein the filter state indicates that first filter information is configured for the second radio bearer or that no filters are configured for the second radio bearer; and means for transmitting a second communication, wherein the second communication is associated with the PDU session, and wherein the second communication is associated with the second radio bearer based on second filter information and one or more traffic parameters of the second communication.

In some aspects, an apparatus for wireless communication includes means for receiving a first communication for establishment of a PDU session for a second network entity; means for transmitting, based on the first communication, first configuration information for a first radio bearer for the PDU session; and means for transmitting, based on the first communication, second configuration information for a second radio bearer for the PDU session based on the second network entity being configured to support multiple radio bearers.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing broadly outlines example features and example technical advantages of examples according to the disclosure. Additional example features and example advantages are described hereinafter.

### BRIEF DESCRIPTION OF THE DRAWINGS

The appended drawings illustrate certain example aspects of this disclosure and are therefore not limiting in scope. The same reference numbers in different drawings may identify the same or similar elements.

FIG. 1 is a diagram illustrating an example environment in which apparatuses and/or methods described herein may be implemented, in accordance with the present disclosure.

FIG. 2 is a diagram illustrating an example of a wireless communication network, in accordance with the present disclosure.

FIG. 3 is a diagram illustrating an example disaggregated network node architecture, in accordance with the present disclosure.

FIG. 4 is a diagram illustrating an example architecture of a functional framework for radio access network intelligence enabled by data collection, in accordance with the present disclosure.

FIG. 5 is a diagram illustrating an example of quality of service establishment or modification, in accordance with the present disclosure.

FIGS. 6A-6B are diagrams of an example associated with a dedicated radio bearer for a protocol data unit (PDU) session, in accordance with the present disclosure.

FIG. 7 is a diagram of an example associated with a dedicated radio bearer for a PDU session, in accordance with the present disclosure.

FIG. 8 is a diagram of an example associated with a dedicated radio bearer for a PDU session, in accordance with the present disclosure.

FIG. 9 is a diagram illustrating an example process performed, for example, at a first network entity or an apparatus of a first network entity, in accordance with the present disclosure.

FIG. 10 is a diagram illustrating an example process performed, for example, at a first network entity or an apparatus of a first network entity, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. The scope of the disclosure covers any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure covers an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In the context of wireless communication, a protocol data unit (PDU) session is a logical data session between a user equipment (UE) and a data network, such as the Internet or a private data network. A PDU session may serve as a dedicated logical channel for transmitting user plan data, such as Internet traffic, voice calls, multimedia traffic, and/or other data traffic, between the UE and the data network. A PDU session may be associated with a PDU type, such as a first PDU type for Internet protocol (IP) data (e.g., internet browsing) or a second PDU type for non-IP data. A PDU session may support different types of services, such as enhanced mobile broadband (eMBB), ultra-reliable low-latency communication (URLLC), and/or massive machine-type communication (mMTC), among other examples.

A UE may transmit a request to establish a PDU session. For example, the UE may transmit the request to a network node (e.g., which may forward the request to a core network node, such as an access and mobility management function (AMF) entity of a core network). The AMF entity may communicate with a session management function (SMF) entity of the core network to create, modify, and/or release a PDU session. After the PDU session is established, data associated with the UE may be communicated between the UE and the core network via a user plane function (UPF) entity.

In some examples, a PDU session may be associated with (e.g., may be configured with) one or more quality of service (QOS) flows. A QoS flow may define one or more QoS parameters. A QOS parameter may be an attribute that defines how communicated data should be treated. For example, a QoS parameter may include a priority level, a throughput parameter (e.g., to define a minimum and/or maximum data rate), a latency parameter (e.g., to define an acceptable delay or response time), a packet loss tolerance parameter (e.g., to define an acceptable packet loss rate), and/or a jitter tolerance parameter (e.g., to define an acceptable variation in delay), among other examples. A QOS flow may be mapped to one or more radio bearers of a wireless communication network. A radio bearer may be a logical channel between the UE and a radio access network (RAN). For example, a radio bearer may be associated with an air interface. The radio bearer may be mapped to physical radio resources. A radio bearer may be a signaling radio bearer (SRB). An SRB may be associated with (e.g., may be used to carry) control plane information (such as radio resource control (RRC) information). Additionally, or alternatively, a radio bearer may be a data radio bearer (DRB). A DRB may be associated with (e.g., may be used to carry) user plane data.

In some examples, one or more QOS parameters may be modified for an existing session (e.g., an existing PDU session) to tune the QoS parameters to a given use case or application executing on a UE. In some examples, the UE may request a change in the one or more QoS parameters, sometimes referred to as UE-initiated QoS modification or UE-initiated PDU session modification. In some other examples, one or more network nodes or core network entities may initiate the change in the one or more QOS parameters, sometimes referred to as network-initiated QoS modification or network-initiated PDU session modification. Such modifications may involve communications between multiple entities and/or operators. For example, an application server may transmit one or more QOS requirements (e.g., for an application managed and/or supported by the application server) to one or more core network entities (e.g., to an application function (AF) via a network exposure function (NEF)). For example, an interface may be made available by the network operator to enable an application server to provide QoS requirements for one or more applications. The core network (e.g., a policy control function (PCF)) may update a policy for a session (e.g., a PDU session) of a UE based on the QoS requirements provided by the application server. The core network (e.g., a user plane function (UPF)) may allocate physical radio resources for a radio bearer that is to be configured with a QoS flow that is based on the QOS requirements provided by the application server. The core network and one or more RAN nodes may set up and/or configure the radio bearer with the QoS flow. The RAN node may configure the UE with the radio bearer, sometimes referred to as a “dedicated” radio bearer (e.g., a radio bearer dedicated for a given application or use case). For example, the configuration of the radio bearer may indicate that traffic associated with the application(s) (e.g., the application(s) indicated as being associated with the one or more QoS requirements by the application server) is to be communicated via the radio bearer (e.g., the dedicated radio bearer). This enables the UE and the RAN node to communicate traffic for the application in accordance with the QOS flow (e.g., the QoS flow that is based on the one or more QoS requirements provided by the application server).

However, this process is complex and involves coordination among multiple entities and/or vendors. For example, the process to modify or set a QoS flow includes multiple communications between the application, the application server, a RAN node, and one or more core network entities. The multiple communications consume network resources and/or processing resources, among other examples. Additionally, the multiple communications may increase latency associated with modifying or setting the QOS flow.

Various aspects relate generally to a dedicated radio bearer for a PDU session. Some aspects more specifically relate to automatic configuration of multiple radio bearers for a UE for a PDU session. In some aspects, when a UE establishes a PDU session, a first radio bearer (e.g., a default radio bearer) and a second radio bearer (e.g., at least one dedicated radio bearer) may be configured for the UE. The first radio bearer may be associated with one or more first QoS parameters and the second radio bearer may be associated with one or more second QoS parameters. The default radio bearer may be “default” in that traffic that is not associated with a traffic type that is mapped to a dedicated radio bearer is communicated via the default radio bearer. The second radio bearer may be configured with a first filter state. As used herein, “filter state” refers to a configuration status indicative of whether one or more filters are configured and, if so, which one or more filters are configured. For example, the first filter state for the second radio bearer may indicate that no filters are configured for the second radio bearer (e.g., the configuration for the second radio bearer may not include any filters). As another example, the first filter state for the second radio bearer may indicate first filter information that is indicative of one or more filters, such as a match-all filter (a match-all filter is a filter that has no conditions, meaning everything will be included in the results).

The UE may transmit data via the second radio bearer based on second filter information. For example, the UE may communicate one or more transmissions associated with the second radio bearer in accordance with a second filter state of the second radio bearer (e.g., that is different than the first filter state configured for the second radio bearer). For example, the UE may transmit a communication that is associated with the PDU session. The communication may be associated with the second radio bearer based on the second filter information and one or more traffic parameters (e.g., an IP flow) of the communication. For example, the second filter information may indicate one or more filters, such as one or more traffic flow template filters. The one or more filters may be configured for detection or identification of one or more traffic types. The one or more traffic types may be associated with the second radio bearer. If the one or more traffic parameters match one or more filters indicated by the second filter information, then the UE may transmit the communication in association with the second radio bearer. If the one or more traffic parameters do not match the one or more filters indicated by the second filter information, then the UE may transmit the communication in association with the first radio bearer. As used herein, one or more traffic parameters may “match” a filter if the filter and the one or more traffic parameters include the same values (such as for a TFT, a source IP address, a destination IP address, a source port number, a destination port number, and/or a protocol).

In some aspects, the UE may autonomously (e.g., without receiving or obtaining instructions or a command to do so from another entity or device) modify the filter state of the second radio bearer from the first filter state to the second filter state. For example, the UE may add or replace one or more filters for the second radio bearer. In some aspects, the UE may obtain the second filter information using one or more artificial intelligence (AI) and/or machine learning (ML) (AI/ML) techniques. For example, the UE may provide a machine learning input that includes traffic flow information (e.g., IP flows, such as a 5-tuple of source IP address, destination IP address, source port, destination port, and transport protocol) for previously communicated traffic. In some aspects, the machine learning input may indicate the one or more traffic types to be communicated via the second radio bearer. The UE may obtain a machine learning output (e.g., that is based on the machine learning input) that indicates the second filter information. For example, an AI/ML model may be configured to detect or identify one or more IP flows associated with the one or more traffic types. The UE may add or replace the one or more filters to enable the UE to identify or detect the one or more IP flows. Additionally, or alternatively, the UE may receive application information (e.g., from a high-level operating system (HLOS) of the UE) indicative of applications executing on the UE. The UE may determine, based on the application information, the one or more IP flows associated with the one or more traffic types.

Particular aspects of the subject matter described in this disclosure can be implemented to realize one or more of the following potential advantages. In some examples, the described techniques can be used to reduce the complexity associated with establishing and/or modifying QoS parameters for a PDU session. For example, by a network node configuring at least two radio bearers for the UE for a PDU session, the UE can modify the filter state of a dedicated radio bearer to enable the UE to transmit traffic associated with a given traffic type via the dedicated radio bearer. This enables the UE to detect traffic to be transmitted in association with the dedicated radio bearer (e.g., that is configured with a different and/or enhanced QoS flow than a default radio bearer) without explicit configuration of the filter information. As a result, the UE can transmit traffic in association with the dedicated radio bearer for one or more desired traffic types, enabling the traffic for the one or more desired traffic types to be handled in accordance with the different and/or enhanced QoS flow. This reduces the complexity and/or conserves resources that would have otherwise been associated with communications between an application server, one or more core network entities, one or more RAN nodes, and the UE to configure the different and/or enhanced QoS flow for the one or more desired traffic types.

Various aspects of the disclosure are described more fully hereinafter with reference to the accompanying drawings. This disclosure may, however, be embodied in many different forms and is not limited to any specific structure, function, example, aspect, or the like presented throughout this disclosure. This disclosure includes, for example, any aspect disclosed herein, whether implemented independently of or combined with any other aspect of the disclosure. For example, an apparatus may be implemented or a method may be practiced using any number of the aspects set forth herein. In addition, the scope of the disclosure includes such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, network node, network entity, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the example concepts disclosed herein, both their organization and method of operation, together with associated example advantages, are described in the following description and in connection with the accompanying figures. Each of the figures is provided for the purposes of illustration and description, and not as a definition of the limits of the claims. Each of the figures is provided for the purposes of illustration and description, and not as a definition of the limits of the claims.

While aspects are described in the present disclosure by illustration to some examples, those skilled in the art understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described example aspects and example features may include additional example components and example features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

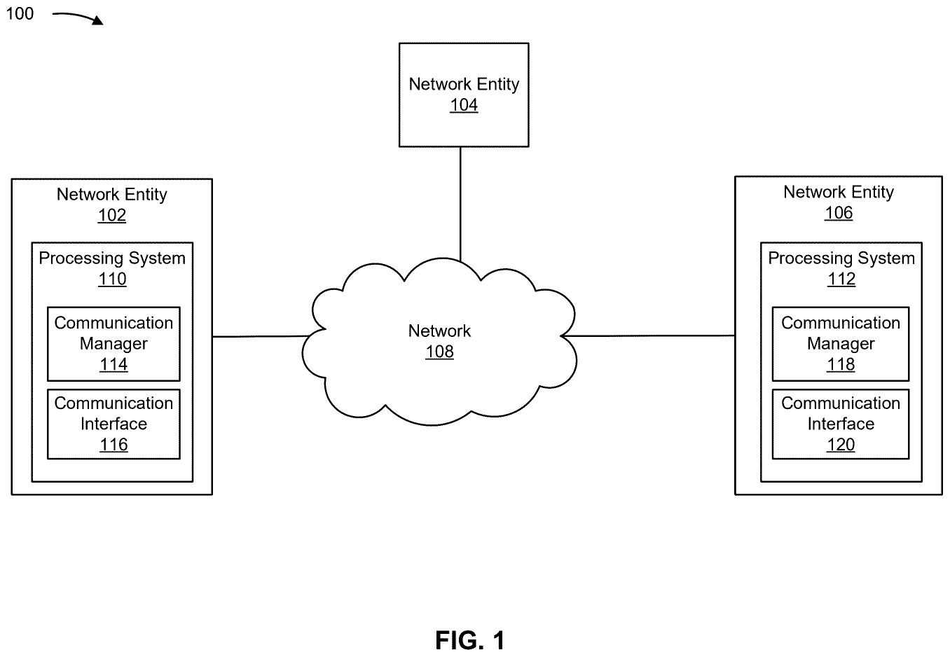

FIG. 1 is a diagram illustrating an example environment 100 in which apparatuses and/or methods described herein may be implemented, in accordance with the present disclosure. As shown in FIG. 1, the environment 100 may include a network entity 102, a network entity 104, and a network entity 106, that may communicate with one another via a network 108. The network entities 102, 104, and 106, may be dispersed throughout the network 108, and each network entity 102, 104, and 106 may be stationary and/or mobile. The network 108 may include wired communication connections, wireless communication connections, or a combination of wired and wireless communication connections.

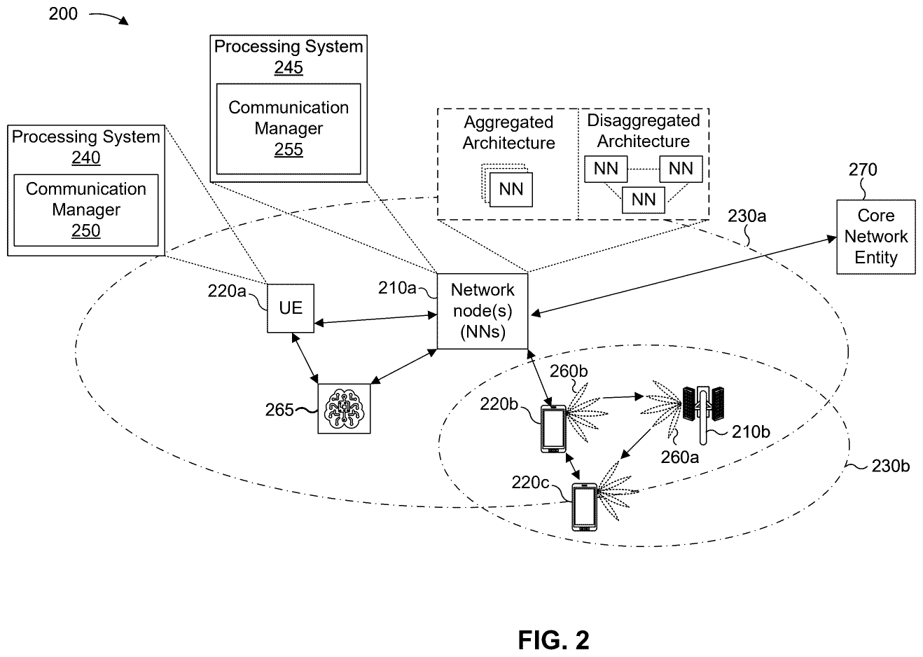

The network 108 may include, for example, a cellular network (e.g., a Long-Term Evolution (LTE) network, a CDMA network, a 4G network, a 5G network, a 6G network, or another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks. The network 108 may include a wireless communication network 200, described in connection with FIG. 2.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in and/or currently operating in the network. Rather, a network entity may be any entity that is capable of communicating and/or operating in the network. A network entity may include a network node 210 or a UE 220, described in more detail in connection with FIG. 2.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity.

Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, “first network entity” may refer to a first UE, a first base station, a first apparatus, a first device, a first computing system, a first set of one or more one or more components, a first processing entity, or the like configured to receive the information; and “second network entity” may refer to a second UE, a second base station, a second apparatus, a second device, a second computing system, a second set of one or more components, a second processing entity, or the like.

As described herein, communication of information (e.g., any information, signal, or the like) may be described in various aspects using different terminology.

Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity 102 may include a processing system 110. Similarly, the network entity 106 may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. A processing system (which may include the processing system 110 and the processing system 112) is described in more detail in connection with FIG. 2, such as in connection with processing system 240 and processing system 245.

As described herein, an “input” and “input information” may be used interchangeably. Similarly, as described herein, an “output” and “output information” may be used interchangeably. Any information generated by any component may be provided to one or more other systems or components of, for example, a network entity described herein. For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

For example, as shown in FIG. 1, the processing system 110 may include a (e.g., one or more) communication manager 114 and one or more communication interfaces 116. The communication manager 114 may be configured to perform one or more communication tasks as described herein. In some aspects, the communication manager 114 may direct the communication interface 120 and/or the processing system 110 to perform one or more communication tasks as described herein. Similarly, the processing system 112 may include a (e.g., one or more) communication manager 118 and one or more communication interfaces 120. The communication manager 118 may be configured to perform one or more communication tasks as described herein. In some aspects, the processing system 112 and/or the communication manager 118 may direct the communication interface 120 to perform one or more communication tasks as described herein. Although depicted, for clarity of description, with reference only to the network entities 102 and 104, any one or more of the network entities 102, 104, and 106 also may include a communication manager and a communication interface.

As used herein, “communication interface” refers to an interface that enables communication (e.g., wireless communication, wired communication, or a combination thereof) between a first network entity and a second network entity. A communication interface may include electronic circuitry that enables a network entity to transmit, receive, or otherwise perform the communication. A communication interface may be, be similar to, include, or be included in one or more components that are configured to enable communication between the first network entity and the second network entity. For example, a communication interface may include a transmission component, a reception component, and/or a transceiver, among other examples. For example, a communication interface may include one or more transceivers, one or more receivers, and/or one or more transmitters configured to communicate with other devices, such as via a wired connection, a wireless connection, or a combination of wired and wireless connections. In some examples, a communication interface may include one or more RF components, an RF front end, one or more antennas, one or more transmit or receive processors, a demodulation component, and/or a modulation component, among other examples.

A communication interface may include a transmission component and/or a reception component. For example, a communication interface may include a transceiver and/or one or more separate receivers and/or transmitters that enable a network entity to communicate with other devices, such as via a wired connection, a wireless connection, or a combination of wired and wireless connections. In some examples, a communication interface may include one or more radio frequency reflective elements and/or one or more radio frequency refractive elements. The communication interface may enable the network entity to receive information from another apparatus and/or provide information to another apparatus. In some examples, the communication interface may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), and/or a serial peripheral interface (SPI), among other examples.

As described herein, a network entity (e.g., the network entity 102 and/or the network entity 106) may be configured to perform one or more operations. Reference to a network entity being configured to perform one or more operations may refer to a processing system of the network entity being configured to perform the one or more operations and/or the processing system being configured to cause one or more components of the network entity to perform the one or more operations. For example, reference to the processing system being configured to perform one or more operations may refer to one or more components (or subcomponents) of the processing system performing the one or more operations. For example, the one or more components of the processing system may include at least one memory, at least one processor, and/or at least one communication interface, among other examples, that are configured to perform one or more (or all) of the one or more operations, and/or any combination thereof. Where reference is made to the network entity and/or the processing system being configured to perform operations, the network entity and/or the processing system may be configured to cause one component to perform all operations, or to cause more than one component to collectively perform the operations. When the network entity and/or the processing system is configured to cause more than one component to collectively perform the operations, each operation need not be performed by each of those components (e.g., different operations may be performed by different components) and/or each operation need not be performed in whole by only one component (e.g., different components may perform different sub-functions of an operation).

As described in more detail elsewhere herein, the network entity 102 may (e.g., the processing system 110 may, or the processing system 110 may cause the communication manager 114 and/or the communication interface 116 to) transmit a first communication for establishment of a PDU session; receive, based on the first communication, first configuration information for a first radio bearer for the PDU session; receive, based on the first communication, second configuration information for a second radio bearer for the PDU session, wherein the second configuration information indicates a filter state of the second radio bearer, wherein the filter state indicates that first filter information is configured for the second radio bearer or that no filters are configured for the second radio bearer; and/or transmit a second communication, wherein the second communication is associated with the PDU session, and wherein the second communication is associated with the second radio bearer based on second filter information and one or more traffic parameters of the second communication. Additionally, or alternatively, the network entity 102 and/or the communication manager 114 may perform one or more other operations described herein.

As described in more detail elsewhere herein, the network entity 106 may (e.g., the processing system 112 may, or the processing system 112 may cause the communication manager 118 and/or the communication interface 120 to) receive a first communication for establishment of a PDU session for a second network entity; transmit, based on the first communication, first configuration information for a first radio bearer for the PDU session; and/or transmit, based on the first communication, second configuration information for a second radio bearer for the PDU session based on the second network entity being configured to support multiple radio bearers. Additionally, or alternatively, the network entity 106 and/or the communication manager 118 may perform one or more other operations described herein.

The number and arrangement of entities shown in FIG. 1 are provided as one or more examples. In practice, there may be additional network entities and/or networks, fewer network entities and/or networks, different network entities and/or networks, or differently arranged network entities and/or networks than those shown in FIG. 1. Furthermore, the network entity 102, 104, and 106 may be implemented using a single apparatus or multiple apparatuses.

FIG. 2 is a diagram illustrating an example of a wireless communication network 200, in accordance with the present disclosure. The wireless communication network 200 may be or may include elements of a 5G (or NR) network or a 6G network, among other examples. The wireless communication network 200 may include multiple network nodes 210. For example, in FIG. 2, the wireless communication network 200 includes a network node (NN) 210a and a network node 210b. The network nodes 210 may support communications with multiple UEs 220. For example, in FIG. 2, the network nodes 210 support communication with a UE 220a, a UE 220b, and a UE 220c. In some examples, a UE 220 may also communicate with other UEs 220 and a network node 210 may communicate with a core network and with other network nodes 210.

The network nodes 210 and the UEs 220 of the wireless communication network 200 may communicate using the electromagnetic spectrum, which may be subdivided by frequency or wavelength into various classes, bands, carriers, and/or channels. For example, devices of the wireless communication network 200 may communicate using one or more operating bands. In some aspects, multiple wireless communication networks 200 may be deployed in a given geographic area. Each wireless communication network 200 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 200 may implement dynamic spectrum sharing (DSS), in which multiple RATs are implemented with dynamic bandwidth allocation (for example, based on user demand) in a single frequency band. In some examples, the wireless communication network 200 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHz), and FR5 (114.25 GHz through 300 GHz). Although a portion of FR1 is greater than 6 GHz, FR 1 is often referred to (interchangeably) as a “sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 210 and/or a UE 220 may include one or more devices, components, or systems that enable communication with other devices, components, or systems of the wireless communication network 200. For example, a UE 220 and a network node 210 may each include one or more chips, system-on-chips (SoCs), chipsets, packages, or devices that individually or collectively constitute or comprise a processing system, such as a processing system 240 of the UE 220 or a processing system 245 of the network node 210. The processing system 240 and the processing system 245 may be similar to other processing systems described herein, such as the processing system 110 and the processing system 112. A processing system (for example, the processing system 240 and/or the processing system 245) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 240 and the processing system 245 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 240 and the processing system 245 may each include or be coupled with one or more modems (such as a cellular (for example, a 5G or 6G compliant) modem). In some examples, one or more processors of the processing system 240 and/or the processing system 245 include or implement one or more of the modems. The processing system 240 and the processing system 245 may also include or be coupled with multiple radios (collectively “the radio”), multiple RF chains, or multiple transceivers, each of which may in turn be coupled with one or more of multiple antennas. In some examples, one or more processors of the processing system 240 and/or the processing system 245 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 240 of the UE 220 or by the processing system 245 of the network node 210).

A network node 210 and a UE 220 may each include one or multiple antennas or antenna arrays. Typical network nodes 210 and UEs 220 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 210 and the UE 220.

A network node 210 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 210 may be implemented as a single physical node (for example, a single physical structure) or may be implemented as two or more physical nodes (for example, two or more distinct physical structures). For example, a network node 210 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 210 may be an aggregated network node having an aggregated architecture, meaning that the network node 210 may implement a full radio protocol stack that is physically and logically integrated within a single physical structure in the wireless communication network 200. For example, an aggregated network node 210 may consist of a single standalone base station or a single TRP that operates with a full radio protocol stack to enable or facilitate communication between a UE 220 and a core network of the wireless communication network 200.

Alternatively, and as also shown, a network node 210 may be a disaggregated network node (sometimes referred to as a disaggregated base station), having a disaggregated architecture, meaning that the network node 210 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 210 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 210 of the wireless communication network 200 may include one or more CUs, one or more DUs, and one or more RUs. A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 220. In some examples, a single network node 210 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 210 (for example, a base station, an RU, or a TRP) may provide communication coverage for a particular geographic area. The term “cell” can refer to a coverage area of a network node 210 or to a network node 210 itself, depending on the context in which the term is used. A network node 210 may support one or more cells (for example, each cell may support communication within an angular (for example, 60 degree) range around the network node). In some examples, a network node 210 may provide communication coverage for a macro cell, a pico cell, a femto cell, or another type of cell. A macro cell may cover a relatively large geographic area (for example, several kilometers in radius) and may allow unrestricted access by UEs 220 with associated service subscriptions. A pico cell may cover a relatively small geographic area and may also allow unrestricted access by UEs 220 with associated service subscriptions. A femto cell may cover a relatively small geographic area (for example, a home) and may allow restricted access by UEs 220 having association with the femto cell (for example, UEs 220 in a closed subscriber group (CSG)). In some examples, a cell may not necessarily be stationary. For example, the geographic area of the cell may move according to the location of an associated mobile network node 210 (for example, a train, a satellite, an unmanned aerial vehicle, or an NTN network node).

The wireless communication network 200 may be a heterogeneous network that includes network nodes 210 of different types, such as macro network nodes, pico network nodes, femto network nodes, relay network nodes, aggregated network nodes, and/or disaggregated network nodes, among other examples. Various different types of network nodes 210 may generally transmit at different power levels, serve different coverage areas (for example, a cell 230a and a cell 230b), and/or have different impacts on interference in the wireless communication network 200 than other types of network nodes 210.

The UEs 220 may be physically dispersed throughout the coverage area of the wireless communication network 200, and each UE 220 may be stationary or mobile. A UE 220 may be, may include, or may also be referred to as an access terminal, a mobile station, or a subscriber unit. A UE 220 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 220 may be classified according to different categories in association with different complexities and/or different capabilities. UEs 220 in a first category may facilitate massive IoT in the wireless communication network 200, and may offer low complexity and/or cost relative to UEs 220 in a second category. UEs 220 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 200, among other examples. A third category of UEs 220 may have mid-tier complexity and/or capability (for example, a capability between that of the UEs 220 of the first category and that of the UEs 220 of the second capability). A UE 220 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 210 may be, may include, or may operate as an RU, a TRP, or a base station that communicates with one or more UEs 220 via a radio access link (which may be referred to as a “Uu” link). The radio access link may include a downlink and an uplink. “Downlink” (or “DL”) refers to a communication direction from a network node 210 to a UE 220, and “uplink” (or “UL”) refers to a communication direction from a UE 220 to a network node 210. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 220 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 210 transmitting a downlink control information (DCI) configuration to the one or more UEs 220) and/or reconfigured (for example, in real-time or near-real-time) according to changing network conditions in the wireless communication network 200 and/or specific requirements of one or more UEs 220. An active BWP defines the operating bandwidth of the UE 220 within the operating bandwidth of the serving cell. The use of BWPs enables more efficient use of the available frequency domain resources in the wireless communication network 200 because fewer frequency domain resources may be allocated to a BWP for a UE 220 (which may reduce the quantity of frequency domain resources that a UE 220 is required to monitor and reduce UE power consumption by enabling the UE to monitor fewer frequency domain resources), leaving more frequency domain resources to be spread across multiple UEs 220. Thus, BWPs may also assist in the implementation of lower-capability (for example, RedCap) UEs 220 by facilitating the configuration of smaller bandwidths for communication by such UEs 220 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 210 to a UE 220. DCI generally contains the information the UE 220 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 220) from a network node 210 to a UE 220. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 220 to a network node 210. An uplink data channel may be used to transmit uplink data (for example, user data associated with a UE 220) from a UE 220 to a network node 210. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples.

UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 210), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 210 to a UE 220, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 210 or UE 220 over a wireless communication channel. In some examples, the network node 210 or the UE 220 (for example, using the processing system 245 or the processing system 240, respectively) may select an MCS (for example, an order of quadrature amplitude modulation (QAM), such as 64-QAM, 128-QAM, or 256-QAM, among other examples) for a downlink signal or an uplink signal. For example, the network node 210 may select an MCS for a downlink signal in accordance with UCI received from the UE 220. The network node 210 may transmit, to the UE 220, an indication of the selected MCS for the downlink signal, such as via DCI that schedules the downlink signal. As another example, the network node 210 may transmit, and the UE 220 may receive, an indication of an MCS to be applied for the one or more uplink signals, such as via DCI scheduling transmission of the one or more uplink signals.

The network node 210 or the UE 220 (such as by using the processing system 245 or the processing system 240, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 210 or the UE 220 (for example, using the processing system 245 or the processing system 240, respectively, and/or one or more coupled encoders or modems) may perform a channel coding operation or a forward error correction (FEC) operation to control errors in transmitted information. For example, the network node 210 or the UE 220 may perform an encoding operation to generate encoded information (such as by selectively introducing redundancy into the information, typically using an error correction code (ECC), such as a polar code or a low-density parity-check (LDPC) code). The network node 210 or the UE 220 (for example, using the processing system 245 and/or one or more modems) may further perform spatial processing (for example, precoding) on the encoded information to generate one or more processed or precoded signals for downlink or uplink transmission, respectively. In some examples, the network node 210 or the UE 220 may perform codebook-based precoding or non-codebook-based precoding. Codebook-based precoding may involve selecting a precoder (for example, a precoding matrix) using a codebook. For example, the network node 210 may provide precoding information indicating which precoder, defined by the codebook, is to be used by the UE 220. Non-codebook-based precoding may involve selecting or deriving a precoder based on, or otherwise associated with, one or more downlink or uplink signal measurements. The network node 210 or the UE 220 may transmit the processed downlink or uplink signals, respectively, via one or more antennas.

The network node 210 or the UE 220 may receive uplink signals or downlink signals, respectively, via one or more antennas. The network node 210 or the UE 220 (for example, using the processing system 245 or the processing system 240, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 210 or the UE 220 via the downlink or uplink signals. The network node 210 or the UE 220 (for example, using the processing system 245 or the processing system 240, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 220 and a network node 210 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 210 and/or UE 220 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 210b may generate one or more beams 260a, and the UE 220b may generate one or more beams 260b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 210 and/or at the UE 220, such as in a network implementing mm Wave technology. Massive MIMO may improve communication reliability by enabling a network node 210 and/or a UE 220 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 210 and the UE 220 may perform one or more beam management operations, such as an initial beam acquisition operation, one or more beam refinement operations, and/or a beam recovery operation. For example, an initial beam acquisition operation may involve the network node 210 transmitting signals (for example, SSBs, CSI-RSs, or other signals) via respective beams (for example, of the beams 260a of the network node 210) and the UE 220 receiving and measuring the signal(s) via respective beams of multiple beams (for example, from the beams 260b of the UE 220) to identify a best beam (or beam pair) for communication between the UE 220 and the network node 210. For example, the UE 220 may transmit an indication (for example, in a message associated with a random access channel (RACH) operation) of a (best) identified beam of the network node 210 (for example, by indicating an SSBRI or other identifier associated with the beam). A beam refinement operation may involve a first device (for example, the UE 220 or the network node 210) transmitting signal(s) via a subset of beams (for example, identified based on, or otherwise associated with, measurements reported as part of one or more other beam management operations). A second device (for example, the network node 210 or the UE 220) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 210 and the UE 220 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 265 (for example, one or more network nodes 210, one or more UEs 220, and/or one or more servers, and/or one or more components of a cloud computing network, among other examples). For example, in an deployment where AI/ML functionality is performed independently at a device 265, sometimes referred to as “overlay AI/ML”, the AI/ML model (or an instance or portion of the AI/ML model) may be deployed at a UE 220 (for example, at the processing system 240), a network node 210 (for example, at the processing system 245), one or more servers, and/or one or more components of a cloud computing network, among other examples. Additionally or alternatively, in a deployment where AI/ML functionality is coordinated between different devices 265, sometimes referred to as “coordinated AI/ML”, or performed at all device and network layers, sometimes referred to as “native AI/ML”, the AI/ML model (or an instance of the AI/ML model) may be deployed at multiple devices 265 (for example, a first portion of the AI/ML model may be deployed at a UE 220 and a second portion of the AI/ML model may be deployed at a network node 210). In other examples of coordinated AI/ML and/or native AI/ML, a first AI/ML model may be deployed at a UE 220 and a second AI/ML model may be deployed at a network node 210. The AI/ML model(s) may be configured to enhance various aspects of the wireless communication network 200 (for example, to increase privacy, reliability, and/or efficient use of network bandwidth, and/or to reduce latency, among other examples). For example, the AI/ML model(s) may be trained to identify patterns or relationships in data corresponding to the wireless communication network 200, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 220, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some examples, one or more devices in the wireless communication network 200 may communicate with a core network entity 270. For example, a core network may include one or more core network entities 270. For example, the core network may be a 5G core (5GC) or a 6G core. A core network entity 270 may include, for example, a mobility management entity (MME), an access and mobility management function (AMF), a gateway, a user plane function (UPF), or another core network entity. A core network entity 270, or a group of core network entities 270, may include a user plane entity that performs user plane related functions, such as packet transfer and IP address allocation. Additionally, or alternatively, a core network entity 270 or a group of core network entities 270 may include a control plane entity that manages functions, such as access, mobility, security, and/or bearer management. In some examples, one or more network nodes 210 may also perform functions. The core network may be associated with a divergent architecture. In some other examples, a service may perform or be configured to perform, for a given function, one or more operations performed by a core network entity 270 of a core network and/or one or more operations performed by a network node 210 of a wireless communication network 200 that incorporates a core network 200 (e.g., in a service-based architecture). For example, a service may be implemented on a physical device or as a cloud implementation (such as a virtual machine or a virtualized network function). In some examples, a service may perform one or more functions described herein as being performed by a core network entity, such as the core network entity 270. In some examples, a UE 220 may send data to the core network entity 270 via a PDU session. The PDU session may be associated with one or more radio bearers. Each radio bearer may be associated with one or more QoS parameters.

In some aspects, the UE 220 may include a communication manager 250. As described in more detail elsewhere herein, the communication manager 250 may transmit a first communication for establishment of a PDU session; receive, based on the first communication, first configuration information for a first radio bearer for the PDU session; receive, based on the first communication, second configuration information for a second radio bearer for the PDU session, wherein the second configuration information indicates a filter state of the second radio bearer, wherein the filter state indicates that first filter information is configured for the second radio bearer or that no filters are configured for the second radio bearer; and transmit a second communication, wherein the second communication is associated with the PDU session, and wherein the second communication is associated with the second radio bearer based on second filter information and one or more traffic parameters of the second communication. Additionally, or alternatively, the communication manager 250 may perform one or more other operations described herein.

In some aspects, the network node 210 may include a communication manager 255. As described in more detail elsewhere herein, the communication manager 255 may receive a first communication for establishment of a PDU session for a second network entity; transmit, based on the first communication, first configuration information for a first radio bearer for the PDU session; and transmit, based on the first communication, second configuration information for a second radio bearer for the PDU session based on the second network entity being configured to support multiple radio bearers. Additionally, or alternatively, the communication manager 255 may perform one or more other operations described herein.

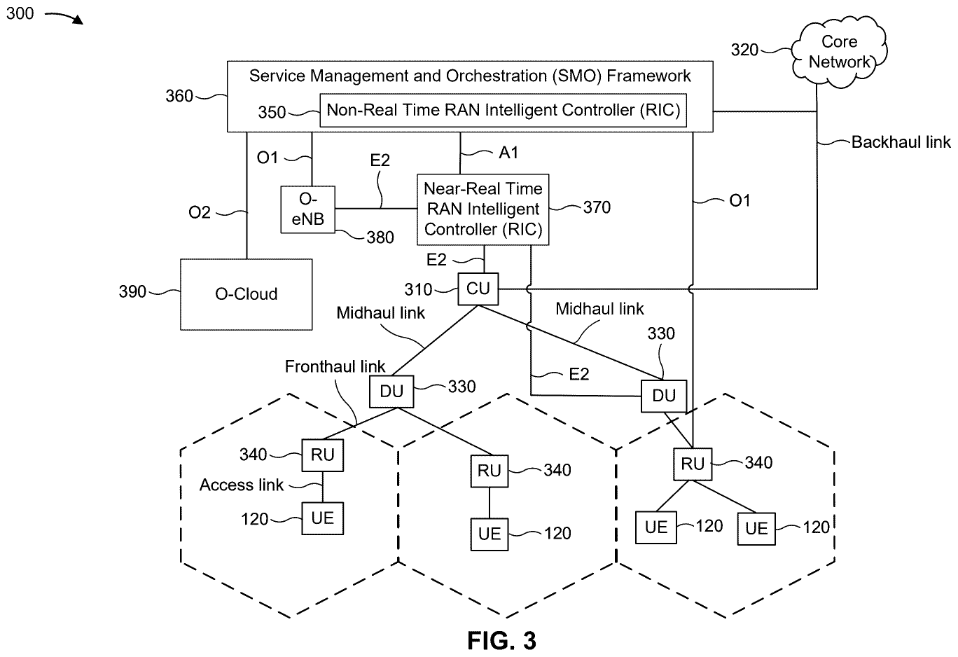

FIG. 3 is a diagram illustrating an example disaggregated network node architecture 300, in accordance with the present disclosure. One or more components of the example disaggregated network node architecture 300 may be, may include, or may be included in one or more network nodes (such one or more network nodes 210). The disaggregated network node architecture 300 may include a CU 310 that can communicate directly with a core network 320 via a backhaul link, or that can communicate indirectly with the core network 320 via one or more disaggregated control units, such as a non-real-time (Non-RT) RAN intelligent controller (RIC) 350 associated with a Service Management and Orchestration (SMO) Framework 360 and/or a near-real-time (Near-RT) RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 220 via respective RF access links. In some deployments, a UE 220 may be simultaneously served by multiple RUs 340.

Each of the components of the disaggregated network node architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB 380 with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

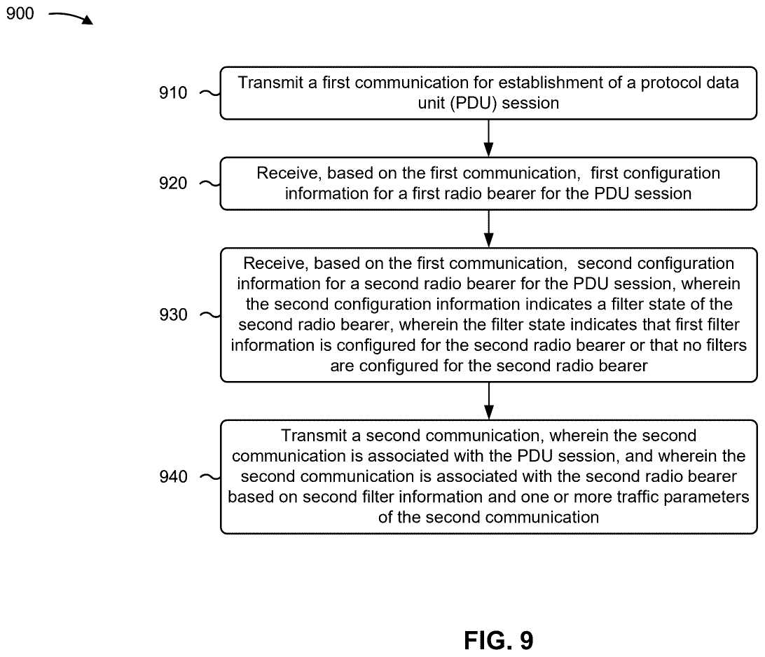

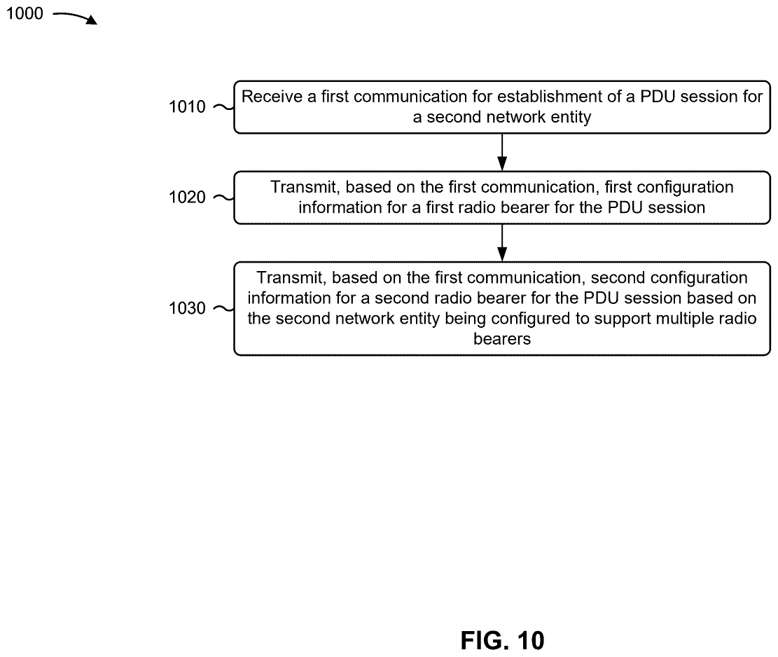

The network entity 102, the processing system 110 of the network entity 102, the network entity 106, the processing system 112 of the network entity 106, the network node 210, the processing system 245 of the network node 210, the UE 220, the processing system 240 of the UE 220, the CU 310, the DU 330, the RU 340, or any other component(s) of FIGS. 1-3 may implement one or more techniques or perform one or more operations associated with a dedicated radio bearer for a PDU session, as described in more detail elsewhere herein. For example, the processing system 110 of the network entity 102, the processing system 112 of the network entity 106, the processing system 245 of the network node 210, the processing system 240 of the UE 220, the CU 310, the DU 330, or the RU 340 may perform or direct operations of, for example, process 900 of FIG. 9, process 1000 of FIG. 10, or other processes as described herein (alone or in conjunction with one or more other processors). Memory of the network node 210 may store data and program code (or instructions) for the network node 210, the CU 310, the DU 330, or the RU 340. In some examples, the memory of the network node 210 may store data relating to a UE 220, such as RRC state information or a UE context. Memory of a UE 220 may store data and program code (or instructions) for the UE 220, such as context information. In some examples, the memory of the UE 220 or the memory of the network node 210 may include a non-transitory computer-readable medium storing a set of instructions for wireless communication. For example, the set of instructions, when executed by one or more processors (for example, of the processing system 110, the processing system 112, the processing system 245, or the processing system 240) of the network entity 102, the network entity 106, the network node 210, the UE 220, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

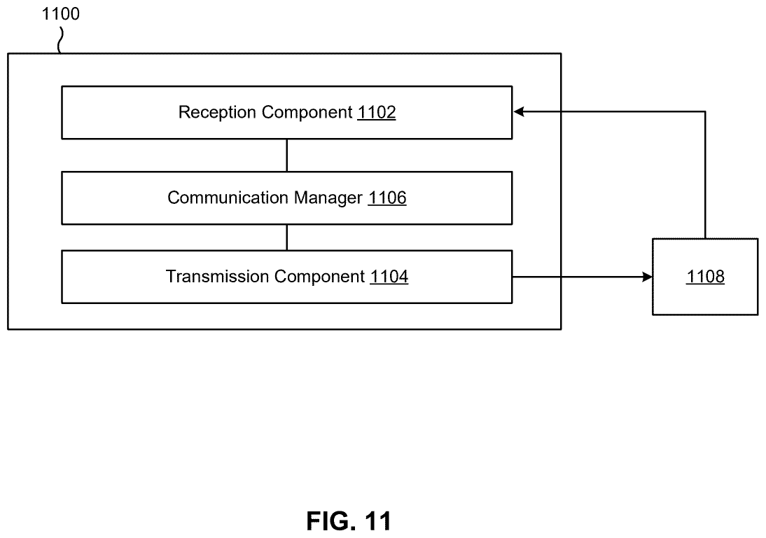

In some aspects, a first network entity includes means for transmitting a first communication for establishment of a PDU session; means for receiving, based on the first communication, first configuration information for a first radio bearer for the PDU session; means for receiving, based on the first communication, second configuration information for a second radio bearer for the PDU session, wherein the second configuration information indicates a filter state of the second radio bearer, wherein the filter state indicates that first filter information is configured for the second radio bearer or that no filters are configured for the second radio bearer; and/or means for transmitting a second communication, wherein the second communication is associated with the PDU session, and wherein the second communication is associated with the second radio bearer based on second filter information and one or more traffic parameters of the second communication. In some aspects, the means for the first network entity to perform operations described herein may include, for example, one or more of communication manager 250, processing system 240, processing system 110, communication manager 114, communication interface 116, processing system 112, communication manager 118, communication interface 120, a radio, one or more RF chains, one or more transceivers, one or more antennas, one or more modems, a reception component (for example, reception component 1102 depicted and described in connection with FIG. 11) and/or a transmission component (for example, transmission component 1104 depicted and described in connection with FIG. 11), among other examples.

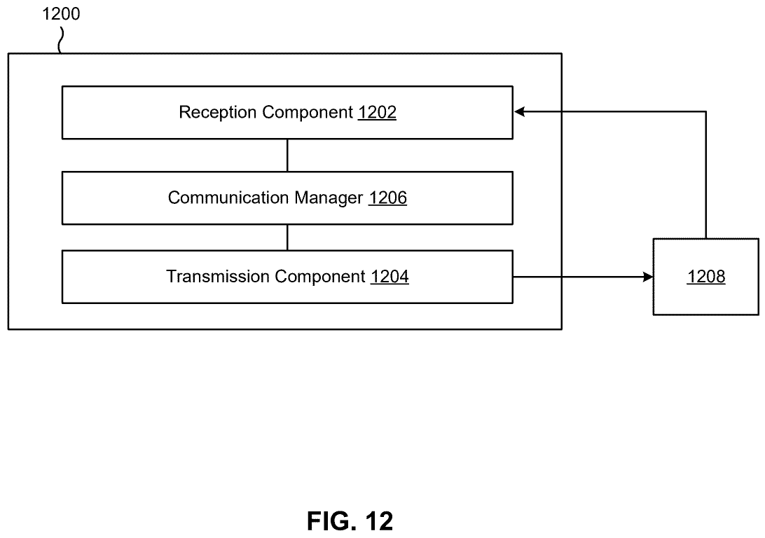

In some aspects, the first network entity includes means for receiving a first communication for establishment of a PDU session for a second network entity; means for transmitting, based on the first communication, first configuration information for a first radio bearer for the PDU session; and/or means for transmitting, based on the first communication, second configuration information for a second radio bearer for the PDU session based on the second network entity being configured to support multiple radio bearers. In some aspects, the means for the first network entity to perform operations described herein may include, for example, one or more of communication manager 255, processing system 245, processing system 110, communication manager 114, communication interface 116, processing system 112, communication manager 118, communication interface 120, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

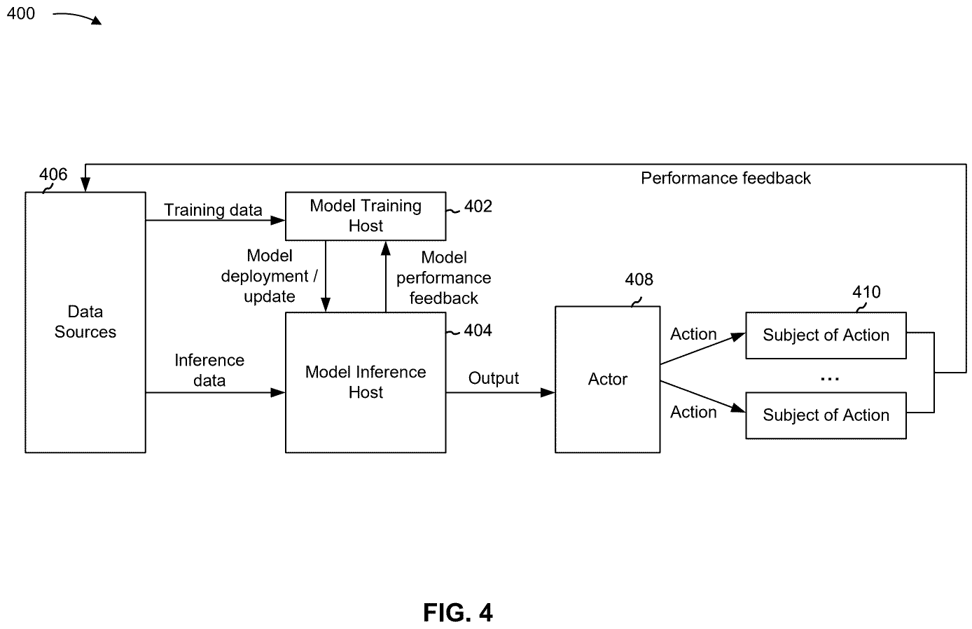

FIG. 4 is a diagram illustrating an example architecture 400 of a functional framework for radio access network (RAN) intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 400, a functional framework for RAN intelligence may include multiple logical entities, such as a model training host 402, a model inference host 404, data sources 406, and an actor 408.

The model inference host 404 may be configured to run an AI/ML model based on inference data provided by the data sources 406, and the model inference host 404 may produce an output (e.g., a prediction) with the inference data input to the actor 408. The actor 408 may be an element or an entity of a core network or a RAN. For example, the actor 408 may be a UE, a network node, base station (e.g., a gNB), a CU, a DU, and/or an RU, among other examples. In addition, the actor 408 may also depend on the type of tasks performed by the model inference host 404, type of inference data provided to the model inference host 404, and/or type of output produced by the model inference host 404. For example, if the output from the model inference host 404 is associated with position determination, the actor 408 may be a UE, a DU or an RU. In some examples, the model inference host 404 may be hosted on the actor 408. For example, a UE may be the actor 408 and may host the model inference host 404. In some aspects, a UE (e.g., the actor 408) may be a data source 406. For example, the UE may perform a measurement (e.g., an NR measurement), may input the measurement to the AI/ML model at the model inference host 404 (or may provide the measurement to the model inference host 404), and may act based on an output of the AI/ML model (e.g., IP flows of one or more traffic types to be communicated via a dedicated radio bearer).

After the actor 408 receives an output from the model inference host 404, the actor 408 may determine whether to act based on the output. For example, if the actor 408 is a UE and the output from the model inference host 404 is associated with position information, the actor 408 may determine whether to report the position information, reconfigure a beam, among other examples. If the actor 408 determines to act based on the output, in some examples, the actor 408 may indicate the action to at least one subject of action 410.

The data sources 406 may also be configured for collecting data that is used as training data for training an ML model or as inference data for feeding an ML model inference operation. For example, the data sources 406 may collect data from one or more core network and/or RAN entities, which may include the actor 408 or the subject of action 410, and provide the collected data to the model training host 402 for ML model training. In some aspects, the model training host 402 may be co-located with the model inference host 404 and/or the actor 408. For example, the actor 408 or the subject of action 410 may provide performance feedback associated with the beam configuration to the data sources 406, where the performance feedback may be used by the model training host 402 for monitoring or evaluating the ML model performance, such as whether the output (e.g., prediction) provided to the actor 408 is accurate. In some examples, the model training host 402 may monitor or evaluate ML model performance using a training position value, which may be provided by a node (e.g., a UE 120 or a network node 110), as described elsewhere herein. In some examples, if the output provided by the actor 408 is inaccurate (or the accuracy is below an accuracy threshold), then the model training host 402 may determine to modify or retrain the ML model used by the model inference host, such as via an ML model deployment/update.

As indicated above, FIG. 4 is provided as an example. Other examples may differ from what is described with regard to FIG. 4.

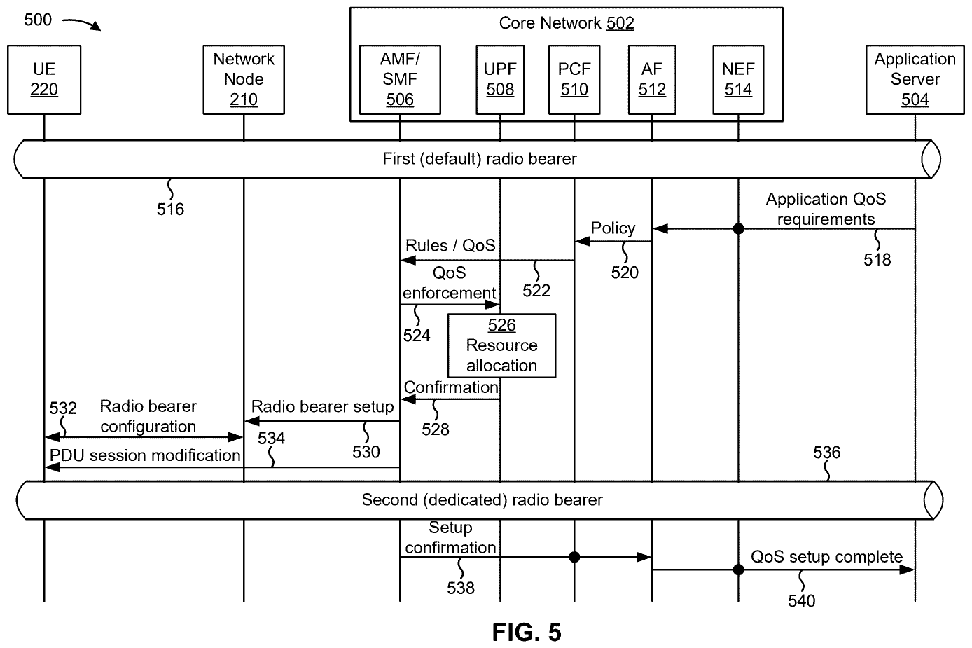

FIG. 5 is a diagram illustrating an example 500 of QoS establishment or modification, in accordance with the present disclosure. As shown in FIG. 5, a UE 220, a network node 210, one or more network entities 502, and an application server 504 may communicate with each other. The example 500 may be an example of network-initiated QoS modification established based at least in part on a request by the application server 504. The application server 504 may be configured to support and/or manage an application executing on the UE 220.

The one or more network entities 502 may include one or more core network entities 270. For example, the one or more network entities 502 may include an AMF/SMF 506, a UPF 508, a PCF 510, an AF 512, and an NEF 514, among other examples. The AF 512 may include one or more devices that support application influence on traffic routing, access to the NEF 514, and/or policy control, among other examples. The AMF of the AMF/SMF 506 may include one or more devices that act as a termination point for non-access stratum (NAS) signaling and/or mobility management, among other examples. The SMF of the AMF/SMF 506 may include one or more devices that support the establishment, modification, and release of communication sessions in the wireless communication network. For example, the SMF may configure traffic steering policies at the UPF 508 and/or enforce UE IP address allocation and policies, among other examples. In some aspects, the SMF may provision network slice instances for the UE 220. The PCF 510 may include one or more devices that provide a policy framework that incorporates network slicing, roaming, packet processing, and/or mobility management, among other examples. In some aspects, the PCF 510 may include one or more URSP rules to select network slice instances for the UE 220.

As shown in FIG. 5, a first radio bearer 516 may be established for the UE 220. The first radio bearer 516 may be associated with a PDU session. The first radio bearer 516 may be a default radio bearer for the PDU session. For example, the UE 220, the network node 210, and the one or more network entities 502 may communicate for PDU establishment of the PDU session. For example, the UE 220 and the AMF/SMF 506 of the one or more network entities 502 may communicate to establish the PDU session. As an example, the PDU session may be a default PDU session for Internet traffic communicated by the UE 220.

As shown by reference number 518, the application server 504 may transmit, and the AF 512 (e.g., via the NEF 514) may receive, one or more application QoS requirements for one or more applications. A QOS requirement may indicate an acceptable value for a given QoS parameter for traffic associated with a given application. A QOS requirement may indicate an acceptable throughput, an acceptable latency, and/or an acceptable packet loss, among other examples, for a given application. In some aspects, the application server 504 may transmit the one or more application QOS requirements based on a request obtained from an application executing on the UE 220.

As shown by reference number 520, the AF 512 may provide, and the PCF 510 may obtain, policy information for the one or more applications. The policy information may include a QoS request. The QoS request may indicate the one or more QOS requirements. The QoS request may indicate that the PCF 510 is requested to establish a policy for the one or more applications in accordance with the one or more QOS requirements.

As shown by reference number 522, the PCF 510 may provide, and the AMF/SMF 506 may obtain, one or more rules and/or one or more QoS parameters. The one or more rules may indicate which applications or traffic are to be associated with the one or more QoS parameters. For example, the PCF 510 may provide a policy update notification to the SMF for the PDU session with rules and QoS changes. The SMF may handle the updated policy rules. As shown by reference number 524, the AMF/SMF 506 may provide, and the UPF 508 may obtain, a QoS enforcement indication. The QoS enforcement indication may indicate the one or more QoS parameters. For example, the SMF may update the PDU session in the UPF 508 with the one or more QoS parameters.

As shown by reference number 526, the UPF 508 may allocate one or more resources (e.g., physical radio resources) for a radio bearer (e.g., a dedicated radio bearer) to be associated with the QoS parameters. As shown by reference number 528, the UPF 508 may provide, and the AMF/SMF 506 may obtain, confirmation that the resources have been allocated and/or that the policy for the PDU session has been successfully updated.

As shown by reference number 530, the AMF/SMF 506 may transmit, and the network node 210 may receive, a radio bearer setup for a second (e.g., dedicated) radio bearer. The radio bearer setup may indicate the PDU session, the one or more QoS parameters, and/or the application(s) to be associated with the second radio bearer, among other examples. As shown by reference number 532, the network node 210 may transmit, and the UE 220 may receive, a radio bearer configuration for the second radio bearer (e.g., in a bearer resource command). As shown by reference number 534, the AMF/SMF 506 may transmit, and the UE 220 may receive, a PDU session modification. The PDU session modification may indicate a QoS flow identifier (QFI), a 5G QFI (5QI), and/or filter information (e.g., one or more traffic flow templates (TFTs)), among other examples. The filter information may be based on the one or more applications (e.g., indicated by the application server 504). For example, the one or more TFTs may be configured for detection of IP flows of the one or more applications. The PDU session modification may indicate information to be associated with the second radio bearer (e.g., indicated by the radio bearer configuration from the network node 210). This enables a second (e.g., dedicated) radio bearer 536 to be established in accordance with the one or more QoS parameters (e.g., that are based on the one or more application QoS requirements provided by the application server 504).

As shown by reference number 538, the AMF/SMF 506 may provide, and the AF 512 may obtain (e.g., via the PCF 510) an indication that the second radio bearer 536 was setup successfully (e.g., a setup confirmation). As shown by reference number 540, the AF 512 may provide (e.g., via the NEF 514), and the application server 504 may obtain, an indication that the application QoS requirements have been setup for the one or more applications.

However, this process is complex and involves coordination among multiple entities and/or vendors. For example, the process to modify or set a QoS flow includes multiple communications between the application, the application server, a RAN node, and one or more core network entities. The multiple communications consume network resources and/or processing resources, among other examples. Additionally, the multiple communications may increase latency associated with modifying or setting the QOS flow.

As indicated above, FIG. 5 is provided as an example. Other examples may differ from what is described with regard to FIG. 5.

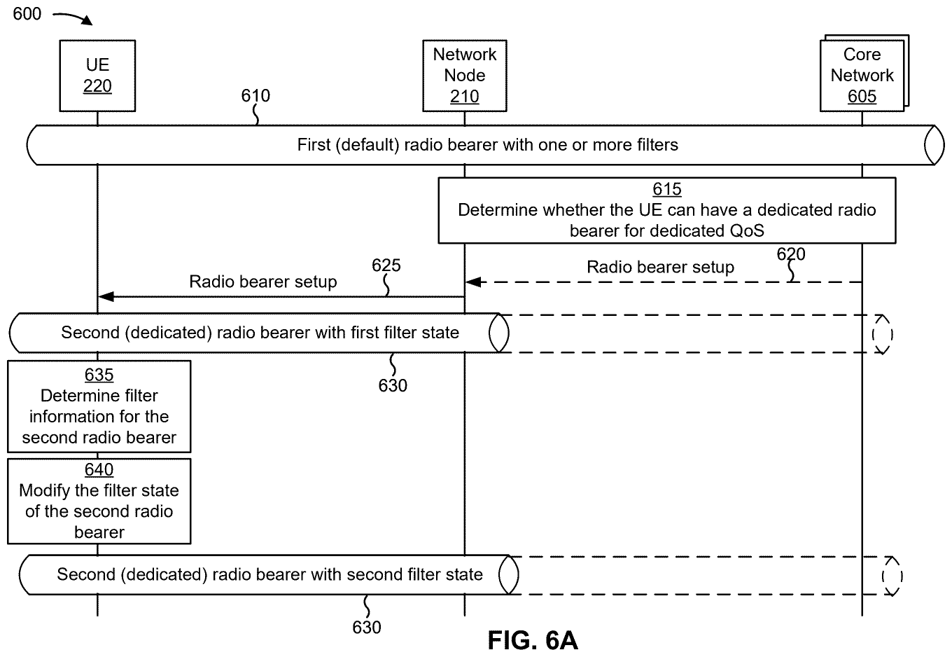

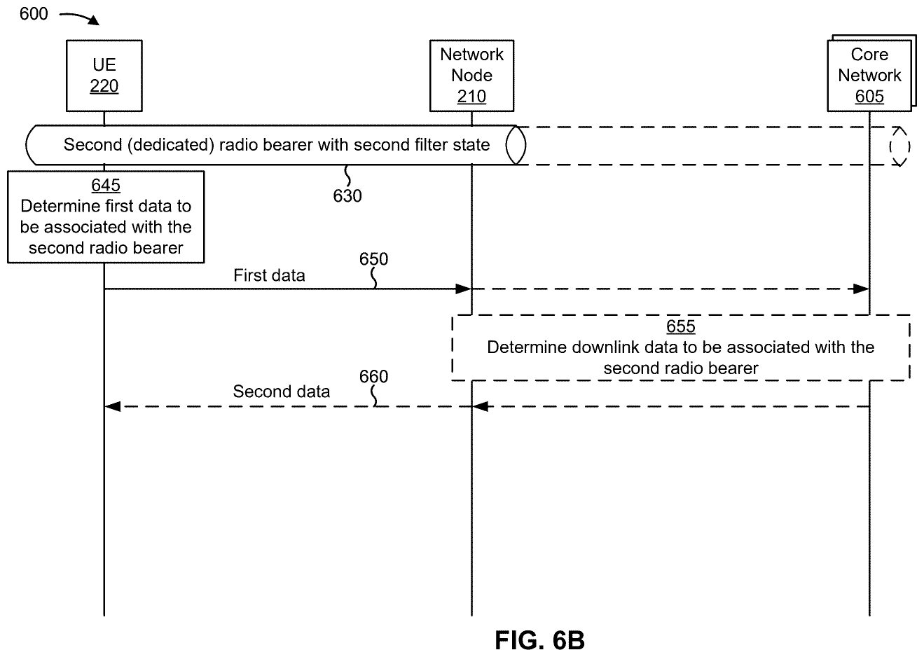

FIGS. 6A-6B are diagrams of an example 600 associated with a dedicated radio bearer for a PDU session, in accordance with the present disclosure. As shown in FIGS. 6A-6B, a UE 220, a network node 210, and one or more core network entities 605 (e.g., one or more core network entities 270) may communicate with each other. In some aspects, the network node 210, the UE 220, and the one or more core network entities 605 may be part of a wireless network (e.g., the wireless communication network 200). The UE 220 and the network node 210 may have established a wireless connection prior to operations shown in FIGS. 6A-6B.

As used herein, a first network entity (e.g., the UE 220, the network node 210, and/or a core network entity 605) “outputting,” “sending,” or “transmitting” a communication to a second network entity (e.g., the UE 220, the network node 210, and/or a core network entity 605) may refer to a direct transmission (for example, from the first network entity to the second network entity) or an indirect transmission via one or more other network entities or devices. For example, if the first network entity is a DU, an indirect transmission to the second network entity may include the DU outputting, sending, or transmitting a communication to an RU and the RU transmitting the communication to the second network entity, or may include causing the RU to transmit the communication (e.g., triggering transmission of a physical layer reference signal). As another example, if the second network entity is a DU, an indirect transmission to the second network entity may include the first network entity transmitting or sending a communication to an RU and the RU transmitting or sending the communication to the second network entity. Similarly, the first network entity “obtaining” or “receiving” a communication may refer to receiving a transmission carrying the communication directly (for example, from the second network entity) or receiving the communication (or information derived from reception of the communication) via one or more other network entities or devices.

In some aspects, the UE 220 may transmit or send capability information. The capability information may be included in a capability report. The UE 220 may transmit or send the capability information via an uplink communication, a sidelink communication, a unicast communication, a broadcast communication, a UE assistance information (UAI) communication, an uplink control information (UCI) communication, a sidelink control information (SCI) communication, a MAC control element (MAC-CE) communication, an RRC communication, a physical uplink control channel (PUCCH), a physical uplink shared channel (PUSCH), a physical sidelink control channel (PSCCH), and/or a physical sidelink shared channel (PSSCH), among other examples. The capability information may indicate one or more parameters associated with respective capabilities of the UE. The one or more parameters may be indicated via respective information elements (IEs) included in a capability report.

The capability information may indicate whether the UE 220 supports a feature and/or one or more parameters related to the feature. For example, the capability information may indicate a capability and/or parameter for supporting network-initiated and/or UE initiated QoS. As another example, the capability information may indicate a capability and/or parameter for supporting an autonomous filtering-based QoS operation, as described in more detail elsewhere herein. For example, the capability information may indicate that the UE 220 supports installing one or more filters to identify traffic (e.g., data and/or packets) to be communicated via a dedicated radio bearer that is associated with a given QoS flow. One or more operations described herein may be based on capability information. For example, the UE 220 may perform a communication in accordance with the capability information, or may receive configuration information that is in accordance with the capability information. In some aspects, the UE 220 may be configured with a second radio bearer for a PDU session (e.g., without the second radio bearer being requested by the UE 220 or another entity) based at least in part on the capability information.

In some aspects, the network node 210 may transmit, and the UE 220 may receive, configuration information. In some aspects, the UE 220 may receive the configuration information via one or more of system information signaling (e.g., a master information block (MIB) and/or a system information block (SIB), among other examples), RRC signaling, MAC signaling (e.g., one or more MAC control elements (MAC-CEs)), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information may not be expressly signaled to the UE 220. For example, in some aspects, the configuration information may at least partially be defined by a wireless communication standard, such as the 3GPP. In such examples, the network node 210 may not explicitly indicate such configuration information to the UE 220. For example, the UE 220 may optionally obtain at least a portion of the configuration information from a configuration stored by the UE 220 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that the UE 220 is to be configured with a first radio bearer (e.g., a default radio bearer) and a second radio bearer (e.g., a dedicated radio bearer) based on establishing a PDU session. For example, the network node 210 and/or one or more core network entities 605 may automatically configure at least one dedicated radio bearer in addition to the default radio bearer for a PDU session associated with the UE. The dedicated radio bearer may be associated with a dedicated QoS flow for one or more traffic types, as described in more detail elsewhere herein.

In some aspects, the configuration information may indicate that the UE 220 is to modify a filter state of the second radio bearer. For example, the configuration information may indicate that the UE 220 is to add and/or replace filter information (e.g., where the filter information indicates one or more filters) for the second radio bearer. The one or more filters may be configured for detection or identification of the one or more traffic types to be communicated via the second radio bearer. In some aspects, the configuration information may indicate the one or more traffic types.

The UE 220 may configure itself based at least in part on the configuration information. In some aspects, the UE 220 may be configured to perform one or more operations described herein based at least in part on the configuration information.

As shown in FIG. 6A, a first radio bearer 610 may be established and/or configured for the UE 220. For example, the UE 220 may transmit or send, and a core network entity 605 (e.g., an AMF) may receive or obtain, a PDU session establishment request. The PDU session establishment request may include a purpose or type of the PDU session, such as Internet, VoIP, video streaming, and/or another type of service.

In some aspects, the network node 210 may obtain the PDU session establishment request from the UE 220. The network node 210 may send, and an AMF may obtain, the PDU session establishment request. The AMF may determine whether the UE 220 is authorized for the PDU session, may handle initial mobility context, and may prepare the request for further processing by another core network entity 605 (e.g., an SMF). The AMF may send, and the SMF may obtain, the PDU session establishment request. The SMF may determine how to handle the PDU session based at least in part on the type of service requested and one or more network policies. The SMF may allocate the first radio bearer 610 for the PDU session. The SMF may indicate one or more QoS parameters for the first radio bearer 610 of the PDU session. The SMF may determine how data should be routed within the network, including interaction with a UPF, which is responsible for handling user data traffic.

The SMF may send, and the network node 210 may obtain, a bearer context setup request indicating information for the first radio bearer 610, one or more QoS parameters, and/or other information for the PDU session. The network node 210 may update a context with the information for the first radio bearer 610. The network node 210 may transmit or send, and the UE 220 may receive or obtain, configuration information for the PDU session. The configuration information may be included in a PDU session establishment accept message for the PDU session. The PDU session establishment accept message may indicate that the network has accepted the PDU session and indicate the information for the first radio bearer 610 (e.g., in a RadioBearerConfig IE), one or more QoS parameters, and/or other information for the PDU session. In some aspects, the UE 220 may transmit or send, and the network node 210 may receive or obtain, a PDU session establishment accept message indicating that the UE 220 is ready for communication via the PDU session. The network node 210 may send, and the AMF may obtain, the PDU session establishment accept message. The SMF may send, and the network node 210 may obtain, a PDU session resource command to finalize the configuration of the PDU session and ensure that a data path is correctly established between the UE 220 and a core network entity 605 (e.g., a UPF of the core network). The network node 210 may apply the bearer resource(s) and/or QoS parameters for the first radio bearer 610 of the PDU session.

The first radio bearer 610 may be a default radio bearer for the PDU session. In some aspects, the first radio bearer 610 may include one or more DRBs. Additionally, or alternatively, the first radio bearer 610 may include one or more SRBs. As described elsewhere herein, the first radio bearer 610 may be a logical channel between the UE 220 and the network node 210. The first radio bearer 610 may be associated with a filter state. For example, the first radio bearer 610 may be configured with filter information indicative of one or more filters. The one or more filters may be configured for detection and/or identification of one or more traffic types or applications. For example, a filter may include a traffic flow template (TFT). For example, a filter may include a tuple that identifies a given application. For example, the tuple may be a 5-tuple that includes a source IP address, a destination IP address, a source port number (e.g., a port number of the source device sending the traffic), a destination port number (e.g., a port number of the source device obtaining the traffic), and a protocol (e.g., a transport layer protocol being used). In some aspects, the filter may be configured for detection or identification of a given IP flow. “IP flow” may refer to information (such as a 5-tuple) indicating a network flow. For example, the IP flow may indicate a source IP address, a source port, a destination IP address, a destination port, and a transport protocol.

The first radio bearer 610 is shown in FIG. 6A to extend to the one or more core network entities 605 to indicate that the one or more core network entities 605 are aware of and/or are associated with configuring, establishing, and/or managing the first radio bearer 610.

As shown by reference number 615, the network node 210 and/or the one or more core network entities 605 may determine whether the UE 220 can have a dedicated radio bearer for dedicated QoS. In some aspects, a core network entity 605 may determine whether the UE 220 can have a dedicated radio bearer for dedicated QoS. For example, the core network entity 605 may be the AMF, the SMF, the UPF, and/or the PCF, among other examples. In examples where the core network entity 605 determines whether the UE 220 can have a dedicated radio bearer, the core network entity 605 may determine whether the UE 220 can have a dedicated radio bearer based on obtaining or receiving the PDU session establishment request from the UE 220. For example, when a PDU session establishment request for a packet data network (PDN) comes from the UE 220, the core network entity 605 (e.g., the UPF of the core network) may autonomously (e.g., without receiving instructions or a command to do so from another core network entity or another device, such as an application server) configure at least two data pipes (e.g., at least two radio bearers) with the RAN (e.g., with the network node 210).

For example, the core network entity 605 (e.g., the UPF of the core network) may determine that the UE 220 is able to support the multiple radio bearers for dedicated QoS. For example, a network operator may configure dedicated QoS flows for respective traffic types. For example, a first dedicated QoS flow may be associated with gaming traffic (e.g., in which the first dedicated QoS flow may be configured with a low-latency QoS parameter). A second dedicated QoS flow may be associated with streaming traffic (e.g., in which the second dedicated QoS flow is configured with a low-packet-loss QoS parameter and/or a low-jitter QoS parameter). The core network entity 605 may determine that the UE 220 supports a dedicated radio bearer for the dedicated QoS flow(s) based on policy information for the UE 220.

In such examples, as shown by reference number 620, the one or more core network entities 605 may transmit or provide, and the network node 210 may receive or obtain, radio bearer setup information for one or more dedicated radio bearers for the PDU session associated with the UE 220. The radio bearer setup information may include configuration information for the one or more dedicated radio bearers, such as QOS configurations for respective dedicated radio bearers.

In some other aspects, the network node 210 may determine whether the UE 220 can have a dedicated radio bearer for dedicated QoS. For example, the network node 210 may determine that the UE 220 can have a dedicated radio bearer for dedicated QoS based on policy information for the UE 220 and/or the capability information of the UE 220. In such examples, the network node 210 may autonomously (e.g., without receiving instructions or a command to do so from a core network entity 605 or another device, such as an application server) configure at least two radio bearers with the UE 220 for the PDU session. For example, the network node 210 may obtain instructions to configure the first radio bearer 610 for the PDU session from a core network entity 605. The network node 210 may determine that at least one dedicated radio bearer should also be configured for the PDU session associated with the UE 220.

As shown by reference number 625, the network node 210 may transmit, and the UE 220 may receive, radio bearer setup information for the at least one dedicated radio bearer. For example, the network node 210 may transmit, and the UE 220 may receive, configuration information for a second radio bearer 630 associated with the PDU session. The configuration information for the second radio bearer 630 may be communicated via RRC signaling, among other examples. The configuration information may be associated with the establishment of the PDU session. For example, prior to communicating data associated with the PDU session, the UE 220 may be configured with the first radio bearer 610 and the second radio bearer 630 for the PDU session. The second radio bearer 630 may be a dedicated radio bearer that is associated with a dedicated QoS flow. The dedicated QoS flow may be configured for a given traffic type. As used herein, “traffic type” refers to a classification or category of network traffic that is associated with a given activity or service. For example, a traffic type may include Internet browsing, gaming, streaming, voice over IP (VOIP), and/or peer-to-peer, among other examples. In some aspects, the configuration information for the second radio bearer 630 may indicate one or more traffic types associated with the second radio bearer 630. In some other aspects, the UE 220 may obtain an indication of the one or more traffic types from memory, such as from an OEM configuration stored by the UE 220.

In some aspects, such as where the core network entity 605 determines that the UE 220 can have a dedicated radio bearer for dedicated QoS (e.g., as described in connection with reference number 615), the one or more core network entities 605 may be aware of the configuration of the second radio bearer 630. In some other aspects, such as where the network node 210 determines that the UE 220 can have a dedicated radio bearer for dedicated QoS (e.g., as described in connection with reference number 615), the one or more core network entities 605 may not be aware of and/or may not manage the configuration of the second radio bearer 630.

The first radio bearer 610 may be associated with one or more first QoS parameters. The second radio bearer 630 may be associated with one or more second QoS parameters. For example, the second radio bearer 630 may be configured with a QOS flow (e.g., one or more QoS parameters) that is designed for (or is optimized for) a given traffic type. For example, the QoS flow (e.g., a dedicated QoS flow) may be designed or configured to improve a user experience at the UE 220 for the given traffic type. In some aspects, the one or more core network entities 605 may provide, and the network node 210 may obtain, the QoS flow for the second radio bearer 630 (e.g., in the radio bearer setup information described in connection with reference number 620). Additionally, or alternatively, the network node 210 may obtain the QoS flow for the second radio bearer 630 from memory. For example, a network operator may configure the QoS flow for the second radio bearer 630.

The configuration information for the second radio bearer 630 may indicate a first filter state for the second radio bearer 630. In some aspects, the first filter state may indicate that no filters (or no filter information) are configured for the second radio bearer 630. For example, the configuration information for the second radio bearer 630 may not include any filter information. The UE 220 may determine (e.g., may infer) that no filters are configured for the second radio bearer 630 based on the configuration information for the second radio bearer 630 not including any filter information. In some other aspects, the first filter state may indicate first filter information for the second radio bearer 630. The first filter information may indicate one or more filters. In some aspects, the first filter information may indicate a match-all filter for the second radio bearer 630.

As shown by reference number 635, the UE 220 may determine filter information (e.g., second filter information) for the second radio bearer 630. In some aspects, the UE 220 (e.g., a processing system of the UE 220, such as the processing system 240) may obtain filter information for the second radio bearer 630. The filter information may include one or more filters. The one or more filters may include one or more TFT filters. In some aspects, the one or more filters are configured for detection or identification of the one or more traffic types to be communicated by the UE 220 via the second radio bearer 630. In some aspects, the one or more filters may include one or more uplink filters (e.g., configured for detection or identification of uplink data associated with the one or more traffic types) and/or one or more downlink traffic types (e.g., configured for detection or identification of downlink data associated with the one or more traffic types). In some aspects, the UE 220 may determine the filter information based at least in part on the application information obtained from an HLOS of the UE 220. For example, the HLOS may provide information associated with one or more applications executing on the UE 220, such as IP flows of the one or more applications. In some aspects, the HLOS may indicate a traffic type associated with the one or more applications. The UE 220 may determine the filter information for the second radio bearer 630 based on the information obtained from the HLOS.

Additionally, or alternatively, the UE 220 may obtain the filter information using one or more AI/ML techniques. For example, the UE 220 may provide or send a machine learning input that includes traffic flow information for previously communicated traffic. In some aspects, the machine learning input may indicate the one or more traffic types to be communicated by the UE 220 via the second radio bearer 630. The machine learning input may be, or may be similar to, the input to the machine inference host 404 described in connection with FIG. 4. The UE 220 may obtain a machine learning output that indicates the filter information (e.g., that indicates the one or more filters for the second radio bearer 630). The machine learning output may indicate one or more IP flows associated with the one or more traffic types to be communicated by the UE 220 via the second radio bearer 630. The machine learning output may be similar to the output from the machine inference host 404 described in connection with FIG. 4.

The UE 220 may install the one or more filters. For example, the UE 220 may configure a processing system of the UE 220 with the one or more filters on a data plane of the processing system. For example, the UE 220 may configure a UPF component of the processing system with the one or more filters. The UE 220 may configure one or more uplink filters and/or one or more downlink filters on the data plane of the processing system.

As shown by reference number 640, the UE 220 may modify the filter state of the second radio bearer 630. For example, the UE 220 may modify the filter state from the first filter state to a second filter state. The second filter state may indicate second filter information. The second filter information may be the filter information determined by the UE 220 as described in connection with reference number 635. For example, the second filter information may indicate one or more filters determined by the UE 220. The one or more filters may be configured for the detection and/or identification of data associated with the one or more traffic types that are associated with the second radio bearer 630 (e.g., one or more traffic types to be communicated in association with the second radio bearer 630). For example, if the first filter state of the second radio bearer 630 indicates that no filters are configured for the second radio bearer 630, then the UE 220 may modify the filter state by adding the one or more filters (e.g., one or more uplink filters and/or one or more downlink filters) to stored configuration information for the second radio bearer 630. For example, the UE 220 may autonomously (e.g., without receiving instructions or a command to do so from the network node 210 or a core network entity 605) add one or more TFT filters (e.g., determined by the UE 220 as described in connection with reference number 635) for the second radio bearer 630.

As another example, if the first filter state of the second radio bearer 630 indicates first filter information (e.g., a match-all filter) configured for the second radio bearer 630, then the UE 220 may modify the filter state by replacing the first filter information with second filter information indicative of one or more filters (e.g., one or more uplink filters and/or one or more downlink filters) in stored configuration information for the second radio bearer 630. For example, the UE 220 may autonomously (e.g., without receiving instructions or a command to do so from the network node 210 or a core network entity 605) replace one or more TFT filters (e.g., determined by the UE 220 as described in connection with reference number 635) for the second radio bearer 630.

In some aspects, the second filter information for the second radio bearer 630 may include one or more uplink filters (e.g., and no downlink filters). For example, the second radio bearer 630 may be used for data transmitted by the UE 220, such as uplink data. In such examples, the second radio bearer 630 may not be used for data received by the UE 220, such as downlink data. In some other aspects, the second filter information for the second radio bearer 630 may include one or more uplink filters and one or more downlink filters. For example, the second radio bearer 630 may be used for data transmitted by the UE 220, such as uplink data. Additionally, in such examples, the second radio bearer 630 may be used for data received by the UE 220, such as downlink data.

As shown in FIG. 6B, and by reference number 645, the UE 220 may determine first data (e.g., uplink data) to be associated with the second radio bearer 630 (e.g., to be communicated in accordance with the QoS flow of the second radio bearer 630). For example, the HLOS of the UE 220 may send, and the processing system of the UE 220 may obtain, data (e.g., one or more packets). The one or more packets may be associated with one or more traffic parameters. For example, the one or more packets may be associated with a source IP address, a source port, a destination IP address, a destination port, and a transport protocol.

The UE 220 may determine whether the one or more traffic parameters match one or more filters (e.g., one or more uplink filters) for the second radio bearer 630. For example, the one or more uplink filters may indicate one or more traffic parameters that are indicative of a traffic type to be communicated in association with the second radio bearer 630. The UE 220 may determine whether the one or more traffic parameters of the one or more packets match (e.g., are the same as or are included in a range indicated by) the one or more traffic parameters indicated by the one or more filters (e.g., one or more uplink filters). If the UE 220 determines that the one or more traffic parameters (e.g., of the packet(s)) do not match the one or more filters, then the UE 220 may transmit or send the data (e.g., the one or more packets) in association with (e.g., in accordance with a QoS flow of) the first radio bearer 610.

Alternatively, if the UE 220 determines that the one or more traffic parameters match the one or more filters, then the UE 220 may transmit or send the data (e.g., the one or more packets) in association with (e.g., in accordance with a QoS flow of) the second radio bearer 630. In some aspects, one or more QFIs may be associated with the second radio bearer 630. The one or more QFIs may be reserved QFIs for dedicated radio bearers that are associated with the dedicated QoS described herein. The UE 220 may indicate a QFI, from the one or more QFIs, when transmitting data in association with the second radio bearer 630. The network node 210 may determine that the data is associated with the second radio bearer 630 based on the data indicate the QFI from the one or more QFIs.

As shown by reference number 650, the UE 220 may transmit or send the data in association with the second radio bearer 630. For example, the UE 220 may transmit a communication (e.g., the indicates that data) that is associated with the second radio bearer 630 based on second filter information and one or more traffic parameters of the communication (e.g., of the data). For example, as described above, if the one or more traffic parameters match one or more filters (e.g., indicated by the second filter information), then the UE 220 may transmit the communication in accordance with a QoS flow of the second radio bearer 630.

The network node 210 may receive the data (e.g., the uplink data). The UE 220 and the network node 210 may apply one or more QoS parameters configured for the radio bearer (e.g., the first radio bearer 610 or the second radio bearer 630) associated with the data (e.g., as indicated by a QFI associated with the data). The network node 210 may provide, and one or more core network entities 605 may obtain, the data. The one or more core network entities 605 may send the data to an application server (e.g., via a data network).

In some aspects, as shown by reference number 655, the network node 210 and/or the one or more core network entities 605 may determine downlink data to be associated with the second radio bearer 630. For example, the network node 210 and/or the one or more core network entities 605 may determine downlink data to be associated with the second radio bearer 630 based on uplink data transmitted by the UE 220 in association with the second radio bearer 630. For example, a core network entity 605 (e.g., the UPF of the core network) may determine one or more downlink filters for the second radio bearer based on the uplink data transmitted by the UE 220 in association with the second radio bearer 630 (e.g., to perform reflective QoS for the downlink data). For example, the core network entity 605 (e.g., the UPF of the core network) may determine one or more IP flows associated with the uplink data. The core network entity 605 may determine one or more downlink filters based on the one or more IP flows. For example, the one or more downlink filters may be configured for detection and/or identification of the one or more IP flows. This enables the core network entity 605 to determine downlink traffic that is to be transmitted in association with the second radio bearer 630 based on the uplink traffic transmitted by the UE 220.

As another example, the network node 210 may determine one or more downlink filters for the second radio bearer based on the uplink data transmitted by the UE 220 in association with the second radio bearer 630 (e.g., to perform reflective QoS for the downlink data). For example, the network node 210 may determine one or more IP flows (e.g., an IP tuple) for the uplink data transmitted by the UE 220 in association with the second radio bearer 630. The network node 210 may use the one or more IP flows to determine one or more downlink filters for the second radio bearer 630. For example, the one or more downlink filters may be configured for detection and/or identification of the one or more IP flows. This enables the network node 210 to determine downlink traffic that is to be transmitted in association with the second radio bearer 630 based on the uplink traffic transmitted by the UE 220.

In some aspects, the network node 210 and/or the core network entity 605 may determine the one or more downlink filters using one or more AI/ML techniques, in a similar manner as described in connection with the UE 220 determining the filter information for the second radio bearer 630. For example, the network node 210 and/or the core network entity 605 may provide a machine learning input that indicates traffic flow information (e.g., IP flows and/or IP tuples) of uplink traffic received from the UE 220 in association with the second radio bearer 630. The network node 210 and/or the core network entity 605 may obtain a machine learning output that indicates the one or more downlink filters (e.g., where the machine learning output is based on the machine learning input).

As shown by reference number 660, if downlink data matches the one or more downlink filters, then the core network entity 605 and/or the network node 210 may transmit the downlink data in association with the second radio bearer 630. The network node 210 and/or the core network entity 605 may determine whether the downlink data matches the one or more downlink filters in a similar manner as described in connection with the UE 220 and reference number 645. This enables the network node 210 and/or the core network entity 605 to provide downlink data in accordance with the QoS flow of the second radio bearer 630 based on the filter information determined by the UE 220. For example, because the network node 210 and/or the core network entity 605 determines the one or more downlink filters based on the uplink data transmitted by the UE 220, the network node 210 and/or the core network entity 605 may determine one or more downlink filters that enable detection of one or more IP flows that the UE 220 has determined are associated with the one or more traffic types (e.g., the one or more traffic types that are associated with the second radio bearer 630).

As indicated above, FIGS. 6A-6B are provided as examples. Other examples may differ from what is described with respect to FIGS. 6A-6B.

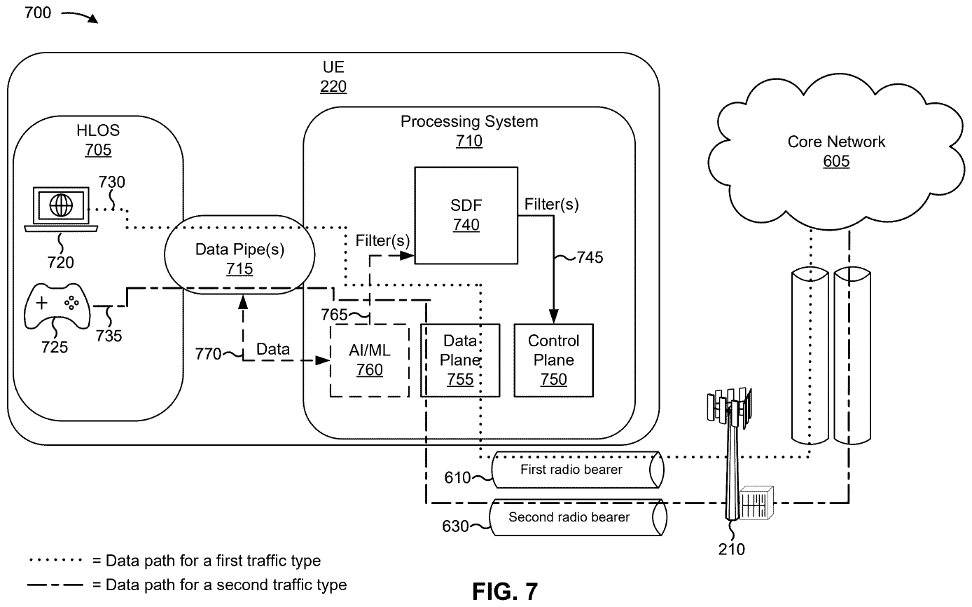

FIG. 7 is a diagram of an example 700 associated with a dedicated radio bearer for a PDU session, in accordance with the present disclosure. As shown in FIG. 7, example 700 includes communication between a UE (e.g., the UE 220), a network node 210, and one or more core network entities 605. As shown in FIG. 7, the UE may include an HLOS 705 and a processing system 710. The processing system 710 may be, or may be similar to, the processing system 240.

As shown in FIG. 7, there may be one or more data pipes 715 between the HLOS 705 and the processing system 710. A data pipe 715 may be an interface for sending and/or obtaining data between the HLOS 705 and the processing system 710. A data pipe 715 may include a software interface and/or a hardware interface to enable the communication of data (e.g., packets or frames, depending on the protocol used) between the HLOS 705 and the processing system 710. For example, application data may be sent by the HLOS 705 to the processing system 710 via a data pipe 715. Data obtained from the network node 210 (e.g., after being processed through a physical layer) may be sent by the processing system 710 to the HLOS 705 via a data pipe 715.

The HLOS 705 may be associated with one or more applications executing on the UE. For example, a first application 720 and a second application 725 may be executing on the UE. The first application 720 may be associated with a first traffic type and the second application 725 may be associated with a second traffic type. As an example, the first application 720 may be associated with Internet browsing traffic (e.g., the first application 720 may be an Internet browser application). The second application 725 may be associated with gaming traffic (e.g., the second application 725 may be a gaming application). As shown in FIG. 7, the first application 720 may be associated with a first data path 730 for traffic (e.g., data and/or packets) associated with the first application 720. The second application 725 may be associated with a second data path 735 for traffic (e.g., data and/or packets) associated with the second application 725. For example, the first data path 730 may include the first radio bearer 610. The second data path 735 may include the second radio bearer 630. For example, a network operator may configure the second traffic type (e.g., gaming traffic) of the second application 725 to be routed via the second radio bearer 630.

As described in more detail elsewhere herein (such as in connection with FIGS. 6A-6B), the UE may route the second traffic type (e.g., gaming traffic) of the second application 725 to the second radio bearer 630 using one or more filters. For example, the UE may include a service data flow (SDF) component 740. As shown by reference number 745, the SDF component 740 may configure one or more filters via a control plane 750 of the processing system 710. This may cause the one or more filters to be installed in a data plane 755 of the processing system 710. As described in more detail elsewhere herein, the one or more filters may enable the processing system 710 to detect data (e.g., one or more packets) that are associated with the second traffic type (e.g., gaming traffic in the example described above) that is to be routed to the second radio bearer 630.

In some aspects, the processing system 710 (e.g., the SDF component 740) may determine the one or more filters based at least in part on information obtained from the HLOS 705. For example, the HLOS 705 may provide, and the processing system 710 may obtain, information regarding one or more applications (e.g., the first application 720 and the second application 725) that are executing on the UE. For example, the information may include traffic parameters (e.g., IP flows) of respective applications. The processing system 710 may determine that the second application 725 is associated with the second traffic type. Therefore, the processing system 710 may configure a filter to enable the processing system 710 to detect data from the second application 725 and determine that the data is associated with the second traffic type.

Additionally, or alternatively, the processing system 710 (e.g., the SDF component 740) may determine the one or more filters based at least in part on an output from an AI/ML component 760 of the UE. The AI/ML component 760 may be, or may include, the model inference host 404. Although the AI/ML component 760 is shown as being included in the processing system 710 as an example, in other examples the AI/ML component 760 may be separate from, or remote from, the processing system 710 (such as in a device 265). The AI/ML component 760 may be configured to output one or more filters (or information that enables the processing system 710 to determine the one or more filters), as shown by reference number 765. For example, as shown by reference number 770, data sent by the HLOS 705 may be input to the AI/ML component 760 (e.g., as a machine learning input). In some aspects, one or more traffic types (e.g., the second traffic type) to be communicated over the second radio bearer 630 may be provided as an input to the AI/ML component 760 (e.g., as a machine learning input). The AI/ML component 760 may be configured to determine, generate, predict, and/or infer, among other examples, one or more filters that enable detection or identification of data (e.g., one or more packets) belonging to the one or more traffic types (e.g., the second traffic type). As shown by reference number 765, the AI/ML component 760 may output, and the processing system 710 (e.g., the SDF component 740) may obtain, information indicative of the one or more filters. This enables the processing system 710 (e.g., the SDF component 740) to configure and/or install the one or more filters on the data plane 755 of the processing system 710.

As described in more detail elsewhere herein (such as in connection with FIGS. 6A-6B), the processing system 710 may determine that the data (e.g., the one or more packets) matches at least one filter (e.g., an uplink filter). This may indicate that the data is associated with a given traffic type. Therefore, while the data is in the data plane 755 of the processing system 710, the processing system 710 may route the data to the second radio bearer 630. This may cause the data to be transmitted or sent by the UE to the network node 210 in accordance with a QoS flow of the second radio bearer 630.

In some aspects, as shown in FIG. 7, the one or more core network entities 605 may be aware of and/or manage the configuration of the first radio bearer 610 and the second radio bearer 630. For example, as described in more detail in connection with FIGS. 6A-6B, the one or more core network entities 605 may use one or more downlink filters to route data to the network node 210 where the data is to be communicated in association with the second radio bearer 630 (e.g., based on one or more traffic parameters of the data matching at least one downlink filter).

As indicated above, FIG. 7 is provided as an example. Other examples may differ from what is described with respect to FIG. 7.

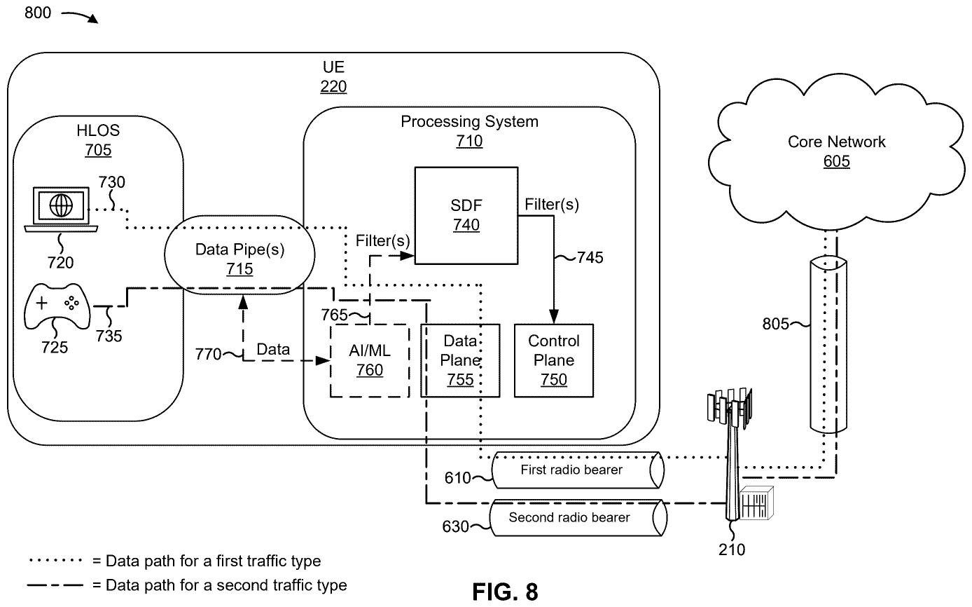

FIG. 8 is a diagram of an example 800 associated with a dedicated radio bearer for a PDU session, in accordance with the present disclosure.

As shown in FIG. 8, the processing system 710 of the UE (e.g., a UE 220) may configure filter information for the second radio bearer 630 in a similar manner as described elsewhere herein, such as in connection with FIGS. 6A-6B and 7. As shown in FIG. 8, the one or more core network entities 605 may not be aware of and/or may not manage the configuration of the second radio bearer 630. As shown by reference number 805, the one or more core network entities 605 may provide data for the PDU session for the first radio bearer 610. The network node 210 may route the data to the first radio bearer 610 or the second radio bearer 630 based on whether one or more traffic parameters of the data match one or more downlink filters. For example, the one or more core network entities 605 may configure the first radio bearer 610 for a PDU session. The network node 210 may configure the second radio bearer 630 for the PDU session. In such examples, the network node 210 may use one or more downlink filters to route data to the UE 220 where the data is to be communicated in association with the second radio bearer 630 (e.g., based on one or more traffic parameters of the data matching at least one downlink filter). For example, the network node 210 may obtain data from the one or more core network entities 605. The network node 210 may determine that the data matches at least one downlink filter. The network node 210 may transmit the data to the UE 220 in accordance with a QoS flow of the second radio bearer 630 based on the data matching at least one downlink filter.

As indicated above, FIG. 8 is provided as an example. Other examples may differ from what is described with respect to FIG. 8.

FIG. 9 is a diagram illustrating an example process 900 performed, for example, at a first network entity or an apparatus of a first network entity, in accordance with the present disclosure. Example process 900 is an example where the apparatus or the first network entity (e.g., the UE 220, the network entity 102, the network entity 104, and/or the network entity 106) performs operations associated with a dedicated radio bearer for a PDU session.

As shown in FIG. 9, in some aspects, process 900 may include transmitting a first communication for establishment of a PDU session (block 910). For example, the first network entity (e.g., using transmission component 1104 and/or communication manager 1106, depicted in FIG. 11) may transmit a first communication for establishment of a PDU session, as described above.

As further shown in FIG. 9, in some aspects, process 900 may include receiving, based on the first communication, first configuration information for a first radio bearer for the PDU session (block 920). For example, the first network entity (e.g., using reception component 1102 and/or communication manager 1106, depicted in FIG. 11) may receive, based on the first communication, first configuration information for a first radio bearer for the PDU session, as described above.

As further shown in FIG. 9, in some aspects, process 900 may include receiving, based on the first communication, second configuration information for a second radio bearer for the PDU session, wherein the second configuration information indicates a filter state of the second radio bearer, wherein the filter state indicates that first filter information is configured for the second radio bearer or that no filters are configured for the second radio bearer (block 930). For example, the first network entity (e.g., using reception component 1102 and/or communication manager 1106, depicted in FIG. 11) may receive, based on the first communication, second configuration information for a second radio bearer for the PDU session, wherein the second configuration information indicates a filter state of the second radio bearer, wherein the filter state indicates that first filter information is configured for the second radio bearer or that no filters are configured for the second radio bearer, as described above.

As further shown in FIG. 9, in some aspects, process 900 may include transmitting a second communication, wherein the second communication is associated with the PDU session, and wherein the second communication is associated with the second radio bearer based on second filter information and one or more traffic parameters of the second communication (block 940). For example, the first network entity (e.g., using transmission component 1104 and/or communication manager 1106, depicted in FIG. 11) may transmit a second communication, wherein the second communication is associated with the PDU session, and wherein the second communication is associated with the second radio bearer based on second filter information and one or more traffic parameters of the second communication, as described above.

Process 900 may include additional aspects, such as any single aspect or any combination of aspects described below and/or in connection with one or more other processes described elsewhere herein.
In a first aspect, the first radio bearer is associated with one or more first QoS parameters, and the second radio bearer is associated with one or more second QoS parameters.
In a second aspect, alone or in combination with the first aspect, the second radio bearer is associated with one or more traffic types, and the second filter information includes one or more filters configured for detection of the one or more traffic types.
In a third aspect, alone or in combination with one or more of the first and second aspects, the second communication is associated with the second radio bearer based on a match between the one or more traffic parameters and the one or more filters.
In a fourth aspect, alone or in combination with one or more of the first through third aspects, process 900 includes receiving an indication of the one or more traffic types.
In a fifth aspect, alone or in combination with one or more of the first through fourth aspects, the one or more filters include one or more traffic flow template filters.
In a sixth aspect, alone or in combination with one or more of the first through fifth aspects, process 900 includes providing a machine learning input that includes traffic flow information for previously communicated traffic, and obtaining a machine learning output that indicates the second filter information, wherein the machine learning output is based on the machine learning input.
In a seventh aspect, alone or in combination with one or more of the first through sixth aspects, the machine learning input indicates one or more traffic types associated with the second radio bearer, and the second filter information includes one or more IP flows associated with the one or more traffic types.
In an eighth aspect, alone or in combination with one or more of the first through seventh aspects, the second filter information includes one or more filters configured for detection of the one or more traffic types, and the one or more filters are based on the one or more IP flows.
In a ninth aspect, alone or in combination with one or more of the first through eighth aspects, process 900 includes obtaining the second filter information via an operating system of the first network entity.
In a tenth aspect, alone or in combination with one or more of the first through ninth aspects, the first filter information indicates a match-all filter for the second radio bearer.
In an eleventh aspect, alone or in combination with one or more of the first through tenth aspects, process 900 includes modifying the filter state of the second radio bearer to indicate the second filter information.
In a twelfth aspect, alone or in combination with one or more of the first through eleventh aspects, the second radio bearer is associated with a logical channel between the first network entity and a second network entity.
In a thirteenth aspect, alone or in combination with one or more of the first through twelfth aspects, the second network entity is a radio access network entity.
In a fourteenth aspect, alone or in combination with one or more of the first through thirteenth aspects, the second network entity is a core network entity.
In a fifteenth aspect, alone or in combination with one or more of the first through fourteenth aspects, the second radio bearer is configured for uplink traffic.
In a sixteenth aspect, alone or in combination with one or more of the first through fifteenth aspects, the second radio bearer is configured for uplink traffic and downlink traffic.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a first network entity or an apparatus of a first network entity, in accordance with the present disclosure. Example process 1000 is an example where the apparatus or the first network entity (e.g., the network node 210, the core network entity 270, the core network entity 605, the network entity 102, the network entity 104, and/or the network entity 106) performs operations associated with a dedicated radio bearer for a PDU session.

As shown in FIG. 10, in some aspects, process 1000 may include receiving a first communication for establishment of a PDU session for a second network entity (block 1010). For example, the first network entity (e.g., using reception component 1202 and/or communication manager 1206, depicted in FIG. 12) may receive a first communication for establishment of a PDU session for a second network entity, as described above.

As further shown in FIG. 10, in some aspects, process 1000 may include transmitting, based on the first communication, first configuration information for a first radio bearer for the PDU session (block 1020). For example, the first network entity (e.g., using transmission component 1204 and/or communication manager 1206, depicted in FIG. 12) may transmit, based on the first communication, first configuration information for a first radio bearer for the PDU session, as described above.

As further shown in FIG. 10, in some aspects, process 1000 may include transmitting, based on the first communication, second configuration information for a second radio bearer for the PDU session based on the second network entity being configured to support multiple radio bearers (block 1030). For example, the first network entity (e.g., using transmission component 1204 and/or communication manager 1206, depicted in FIG. 12) may transmit, based on the first communication, second configuration information for a second radio bearer for the PDU session based on the second network entity being configured to support multiple radio bearers, as described above.

Process 1000 may include additional aspects, such as any single aspect or any combination of aspects described below and/or in connection with one or more other processes described elsewhere herein.
In a first aspect, the first radio bearer is associated with one or more first QoS parameters, and the second radio bearer is associated with one or more second QoS parameters.
In a second aspect, alone or in combination with the first aspect, process 1000 includes transmitting a second communication, wherein the second communication is associated with the second radio bearer based on filter information and one or more traffic parameters of the second communication.
In a third aspect, alone or in combination with one or more of the first and second aspects, the filter information is first filter information, and the second configuration information indicates a filter state of the second radio bearer, wherein the filter state indicates second filter information for the second radio bearer, or that no filters are configured for the second radio bearer.
In a fourth aspect, alone or in combination with one or more of the first through third aspects, the second filter information indicates a match-all filter for the second radio bearer.
In a fifth aspect, alone or in combination with one or more of the first through fourth aspects, the second radio bearer is associated with one or more traffic types, and the filter information includes one or more filters configured for detection of the one or more traffic types.
In a sixth aspect, alone or in combination with one or more of the first through fifth aspects, the second communication is associated with the second radio bearer based on a match between the one or more traffic parameters and the one or more filters.
In a seventh aspect, alone or in combination with one or more of the first through sixth aspects, process 1000 includes transmitting an indication of the one or more traffic types.
In an eighth aspect, alone or in combination with one or more of the first through seventh aspects, the one or more filters include one or more traffic flow template filters.
In a ninth aspect, alone or in combination with one or more of the first through eighth aspects, process 1000 includes providing a machine learning input that includes traffic flow information for previously communicated traffic, and obtaining a machine learning output that indicates the filter information, wherein the machine learning output is based on the machine learning input.
In a tenth aspect, alone or in combination with one or more of the first through ninth aspects, the machine learning input indicates one or more traffic types associated with the second radio bearer, and the filter information includes one or more IP flows associated with the one or more traffic types.
In an eleventh aspect, alone or in combination with one or more of the first through tenth aspects, the filter information includes one or more filters configured for detection of the one or more traffic types, and the one or more filters are based on the one or more IP flows.
In a twelfth aspect, alone or in combination with one or more of the first through eleventh aspects, process 1000 includes receiving one or more third communications associated with the second radio bearer, wherein the one or more third communications are associated with the second network entity, and wherein the filter information is based on traffic flow information of the one or more third communication.
In a thirteenth aspect, alone or in combination with one or more of the first through twelfth aspects, the second radio bearer is associated with a logical channel between the first network entity and the second network entity.
In a fourteenth aspect, alone or in combination with one or more of the first through thirteenth aspects, the first network entity is a radio access network entity.
In a fifteenth aspect, alone or in combination with one or more of the first through fourteenth aspects, the first network entity is a core network entity.
In a sixteenth aspect, alone or in combination with one or more of the first through fifteenth aspects, the second radio bearer is configured for uplink traffic.
In a seventeenth aspect, alone or in combination with one or more of the first through sixteenth aspects, the second radio bearer is configured for uplink traffic and downlink traffic.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a network entity, or a network entity may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 114, the communication manager 118, and/or the communication manager 250. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 110, the processing system 112, and/or the processing system 240).

In some aspects, the apparatus 1100 may be configured to perform one or more operations described herein in connection with FIGS. 6A, 6B, 7, and/or 8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network entity described in connection with FIGS. 1-3. Additionally, or alternatively, one or more components shown in FIG. 11 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components described above in connection with FIGS. 1-3, such as a radio, one or more RF chains, one or more transceivers, or one or more modems, each of which may in turn be coupled with one or more antennas of the network entity.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components described above in connection with FIGS. 1-3, such as a radio, one or more RF chains, one or more transceivers, or one or more modems, each of which may in turn be coupled with one or more antennas described in connection with FIGS. 1-3. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit a first communication for establishment of a PDU session. The reception component 1102 may receive, based on the first communication, first configuration information for a first radio bearer for the PDU session. The reception component 1102 may receive, based on the first communication, second configuration information for a second radio bearer for the PDU session, wherein the second configuration information indicates a filter state of the second radio bearer, wherein the filter state indicates that first filter information is configured for the second radio bearer or that no filters are configured for the second radio bearer. The transmission component 1104 may transmit a second communication, wherein the second communication is associated with the PDU session, and wherein the second communication is associated with the second radio bearer based on second filter information and one or more traffic parameters of the second communication.

The reception component 1102 may receive an indication of the one or more traffic types. The communication manager 1106 may provide a machine learning input that includes traffic flow information for previously communicated traffic.

The reception component 1102 may obtain a machine learning output that indicates the second filter information, wherein the machine learning output is based on the machine learning input. The reception component 1102 may obtain the second filter information via an operating system of the first network entity.

The communication manager 1106 may modify the filter state of the second radio bearer to indicate the second filter information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network entity, or a network entity may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 114, the communication manger 118, and/or the communication manager 255. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 110, the processing system 112, and/or the processing system 245).

In some aspects, the apparatus 1200 may be configured to perform one or more operations described herein in connection with FIGS. 6A, 6B, 7, and/or 8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components described in connection with FIGS. 1-3. Additionally, or alternatively, one or more components shown in FIG. 12 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components described above in connection with FIGS. 1-3, such as a radio, one or more RF chains, one or more transceivers, or one or more modems, each of which may in turn be coupled with one or more antennas of the network entity.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components described above in connection with FIGS. 1-3, such as a radio, one or more RF chains, one or more transceivers, or one or more modems, each of which may in turn be coupled with one or more antennas described in connection with FIGS. 1-3. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive a first communication for establishment of a PDU session for a second network entity. The transmission component 1204 may transmit, based on the first communication, first configuration information for a first radio bearer for the PDU session. The transmission component 1204 may transmit, based on the first communication, second configuration information for a second radio bearer for the PDU session based on the second network entity being configured to support multiple radio bearers.

The transmission component 1204 may transmit a second communication, wherein the second communication is associated with the second radio bearer based on filter information and one or more traffic parameters of the second communication.

The transmission component 1204 may transmit an indication of the one or more traffic types. The communication manager 1206 may provide a machine learning input that includes traffic flow information for previously communicated traffic.

The reception component 1202 may obtain a machine learning output that indicates the filter information, wherein the machine learning output is based on the machine learning input. The reception component 1202 may receive one or more third communications associated with the second radio bearer, wherein the one or more third communications are associated with the second network entity, and wherein the filter information is based on traffic flow information of the one or more third communication.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a first network entity, comprising: transmitting a first communication for establishment of a protocol data unit (PDU) session; receiving, based on the first communication, first configuration information for a first radio bearer for the PDU session; receiving, based on the first communication, second configuration information for a second radio bearer for the PDU session, wherein the second configuration information indicates a filter state of the second radio bearer, wherein the filter state indicates that first filter information is configured for the second radio bearer or that no filters are configured for the second radio bearer; and transmitting a second communication, wherein the second communication is associated with the PDU session, and wherein the second communication is associated with the second radio bearer based on second filter information and one or more traffic parameters of the second communication.
Aspect 2: The method of Aspect 1, wherein the first radio bearer is associated with one or more first quality of service (QOS) parameters, and wherein the second radio bearer is associated with one or more second QoS parameters.
Aspect 3: The method of any of Aspects 1-2, wherein the second radio bearer is associated with one or more traffic types, and wherein the second filter information includes one or more filters configured for detection of the one or more traffic types.
Aspect 4: The method of Aspect 3, wherein the second communication is associated with the second radio bearer based on a match between the one or more traffic parameters and the one or more filters.
Aspect 5: The method of any of Aspects 3-4, further comprising receiving an indication of the one or more traffic types.
Aspect 6: The method of any of Aspects 3-5, wherein the one or more filters include one or more traffic flow template filters.
Aspect 7: The method of any of Aspects 1-6, further comprising: providing a machine learning input that includes traffic flow information for previously communicated traffic; and obtaining a machine learning output that indicates the second filter information, wherein the machine learning output is based on the machine learning input.
Aspect 8: The method of Aspect 7, wherein the machine learning input indicates one or more traffic types associated with the second radio bearer, and wherein the second filter information includes one or more Internet protocol (IP) flows associated with the one or more traffic types.
Aspect 9: The method of Aspect 8, wherein the second filter information includes one or more filters configured for detection of the one or more traffic types, and wherein the one or more filters are based on the one or more IP flows.
Aspect 10: The method of any of Aspects 1-9, further comprising obtaining the second filter information via an operating system of the first network entity.
Aspect 11: The method of any of Aspects 1-10, wherein the first filter information indicates a match-all filter for the second radio bearer.
Aspect 12: The method of any of Aspects 1-11, further comprising: modifying the filter state of the second radio bearer to indicate the second filter information.
Aspect 13: The method of any of Aspects 1-12, wherein the second radio bearer is associated with a logical channel between the first network entity and a second network entity.
Aspect 14: The method of Aspect 13, wherein the second network entity is a radio access network entity.
Aspect 15: The method of Aspect 13, wherein the second network entity is a core network entity.
Aspect 16: The method of any of Aspects 1-15, wherein the second radio bearer is configured for uplink traffic.
Aspect 17: The method of any of Aspects 1-16, wherein the second radio bearer is configured for uplink traffic and downlink traffic.
Aspect 18: A method of wireless communication performed by a first network entity, comprising: receiving a first communication for establishment of a protocol data unit (PDU) session for a second network entity; transmitting, based on the first communication, first configuration information for a first radio bearer for the PDU session; and transmitting, based on the first communication, second configuration information for a second radio bearer for the PDU session based on the second network entity being configured to support multiple radio bearers.
Aspect 19: The method of Aspect 18, wherein the first radio bearer is associated with one or more first quality of service (QOS) parameters, and wherein the second radio bearer is associated with one or more second QoS parameters.
Aspect 20: The method of any of Aspects 18-19, further comprising transmitting a second communication, wherein the second communication is associated with the second radio bearer based on filter information and one or more traffic parameters of the second communication.
Aspect 21: The method of Aspect 20, wherein the filter information is first filter information, and wherein the second configuration information indicates a filter state of the second radio bearer, wherein the filter state indicates: second filter information for the second radio bearer, or that no filters are configured for the second radio bearer.
Aspect 22: The method of Aspect 21, wherein the second filter information indicates a match-all filter for the second radio bearer.
Aspect 23: The method of any of Aspects 20-22, wherein the second radio bearer is associated with one or more traffic types, and wherein the filter information includes one or more filters configured for detection of the one or more traffic types.
Aspect 24: The method of Aspect 23, wherein the second communication is associated with the second radio bearer based on a match between the one or more traffic parameters and the one or more filters.
Aspect 25: The method of any of Aspects 23-24, further comprising transmitting an indication of the one or more traffic types.
Aspect 26: The method of any of Aspects 23-25, wherein the one or more filters include one or more traffic flow template filters.
Aspect 27: The method of any of Aspects 20-26, further comprising: providing a machine learning input that includes traffic flow information for previously communicated traffic; and obtaining a machine learning output that indicates the filter information, wherein the machine learning output is based on the machine learning input.
Aspect 28: The method of Aspect 27, wherein the machine learning input indicates one or more traffic types associated with the second radio bearer, and wherein the filter information includes one or more Internet protocol (IP) flows associated with the one or more traffic types.
Aspect 29: The method of Aspect 28, wherein the filter information includes one or more filters configured for detection of the one or more traffic types, and wherein the one or more filters are based on the one or more IP flows.
Aspect 30: The method of any of Aspects 18-29, further comprising: receiving one or more third communications associated with the second radio bearer, wherein the one or more third communications are associated with the second network entity, and wherein the filter information is based on traffic flow information of the one or more third communication.
Aspect 31: The method of any of Aspects 18-30, wherein the second radio bearer is associated with a logical channel between the first network entity and the second network entity.
Aspect 32: The method of any of Aspects 18-31, wherein the first network entity is a radio access network entity.
Aspect 33: The method of any of Aspects 18-32, wherein the first network entity is a core network entity.
Aspect 34: The method of any of Aspects 18-33, wherein the second radio bearer is configured for uplink traffic.
Aspect 35: The method of any of Aspects 18-34, wherein the second radio bearer is configured for uplink traffic and downlink traffic.
Aspect 36: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-35.
Aspect 37: An apparatus for wireless communication at a device, the apparatus comprising one or more memories and one or more processors coupled to the one or more memories, the one or more processors configured to cause the device to perform the method of one or more of Aspects 1-35.
Aspect 38: An apparatus for wireless communication, the apparatus comprising at least one means for performing the method of one or more of Aspects 1-35 .
Aspect 39: A non-transitory computer-readable medium storing code for wireless communication, the code comprising instructions executable by one or more processors to perform the method of one or more of Aspects 1-35.
Aspect 40: A non-transitory computer-readable medium storing a set of instructions for wireless communication, the set of instructions comprising one or more instructions that, when executed by one or more processors of a device, cause the device to perform the method of one or more of Aspects 1-35.
Aspect 41: A device for wireless communication, the device comprising a processing system that includes one or more processors and one or more memories coupled with the one or more processors, the processing system configured to cause the device to perform the method of one or more of Aspects 1-35.
Aspect 42: An apparatus for wireless communication at a device, the apparatus comprising one or more memories and one or more processors coupled to the one or more memories, the one or more processors individually or collectively configured to cause the device to perform the method of one or more of Aspects 1-35.
Aspect 43: A device for wireless communication, the device comprising a processing system, the processing system configured to perform the method of one or more of Aspects 1-35
Aspect 44: A non-transitory computer-readable medium having code stored thereon that, when executed by a device, causes the device to perform the method of one or more of Aspects 1-35

The foregoing disclosure provides illustration and description but is neither exhaustive nor limiting of the scope of this disclosure. For example, various aspects and examples are disclosed herein, but this disclosure is not limited to the precise form in which such aspects and examples are described. Modifications and variations may be made in light of the above disclosure or may be acquired from practice of the aspects.

As used herein, the term “component” shall be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. Systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and/or measuring, among other examples. Also, “determining” can include receiving (such as receiving information), accessing (such as accessing data stored in memory), and/or transmitting (such as transmitting information), among other examples. As another example, “determining” can include resolving, selecting, obtaining, choosing, establishing, and/or other such similar actions.

Even though particular combinations of features are recited in the claims and/or disclosed in the specification, these combinations do not limit the scope of the disclosure. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As used herein, a phrase referring to “at least one of” a list of items refers to any combination of those items, including single members. As an example, “at least one of: a, b, or c” covers a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” include one or more items and may be used interchangeably with “one or more.” Further, as used herein, the article “the” may include one or more items referenced in connection with the article “the” and may be used interchangeably with “the one or more.” Furthermore, as used herein, the terms “set” and “group” may include one or more items and may be used interchangeably with “one or more.” Where only one item is intended, the phrase “only one” or similar language is used. Also, as used herein, the terms “has,” “have,” “having,” and similar terms are open-ended terms that do not limit an element that they modify (for example, an element “having” A may also have B). Further, the phrase “based on” means “based on or otherwise in association with” unless explicitly stated otherwise. Additionally, as used herein, the phrase “based on” shall not be construed as a reference to a closed set of information, one or more conditions, one or more factors, or the like. Also, as used herein, the term “or” is inclusive when used in a series and may be used interchangeably with “and/or,” unless explicitly stated otherwise (for example, if used in combination with “either” or “only one of”). Further, “one or more” may be equivalent to “at least one.”

Even though particular combinations of features are recited in the claims or disclosed in the specification, these combinations are not limiting of the disclosure of various aspects. Many of these features may be combined in ways not specifically recited in the claims or disclosed in the specification. The disclosure of various aspects includes each dependent claim in combination with every other claim in the claim set.

What is claimed is:

1. A first network entity, comprising:
a processing system configured to:
transmit a first communication for establishment of a protocol data unit (PDU) session;
receive, based on the first communication, first configuration information for a first radio bearer for the PDU session;
receive, based on the first communication, second configuration information for a second radio bearer for the PDU session, wherein the second configuration information indicates a filter state of the second radio bearer, wherein the filter state indicates that first filter information is configured for the second radio bearer or that no filters are configured for the second radio bearer; and
transmit a second communication, wherein the second communication is associated with the PDU session, and wherein the second communication is associated with the second radio bearer based on second filter information and one or more traffic parameters of the second communication.

2. The first network entity of claim 1, wherein the first radio bearer is associated with one or more first quality of service (QOS) parameters, and wherein the second radio bearer is associated with one or more second QoS parameters.

3. The first network entity of claim 1, wherein the second radio bearer is associated with one or more traffic types, and wherein the second filter information includes one or more filters configured for detection of the one or more traffic types.

4. The first network entity of claim 3, wherein the second communication is associated with the second radio bearer based on a match between the one or more traffic parameters and the one or more filters.

5. The first network entity of claim 3, wherein the processing system is configured to receive an indication of the one or more traffic types.

6. The first network entity of claim 3, wherein the one or more filters include one or more traffic flow template filters.

7. The first network entity of claim 1, wherein the processing system is configured to:
provide a machine learning input that includes traffic flow information for previously communicated traffic; and
obtain a machine learning output that indicates the second filter information, wherein the machine learning output is based on the machine learning input.

8. The first network entity of claim 7, wherein the machine learning input indicates one or more traffic types associated with the second radio bearer, and wherein the second filter information includes one or more Internet protocol (IP) flows associated with the one or more traffic types.

9. The first network entity of claim 8, wherein the second filter information includes one or more filters configured for detection of the one or more traffic types, and wherein the one or more filters are based on the one or more IP flows.

10. The first network entity of claim 1, wherein the processing system is configured to obtain the second filter information via an operating system of the first network entity.

11. The first network entity of claim 1, wherein the first filter information indicates a match-all filter for the second radio bearer.

12. The first network entity of claim 1, wherein the processing system is configured to:
modify the filter state of the second radio bearer to indicate the second filter information.

13. A first network entity, comprising:
a processing system configured to:
receive a first communication for establishment of a protocol data unit (PDU) session for a second network entity;
transmit, based on the first communication, first configuration information for a first radio bearer for the PDU session; and
transmit, based on the first communication, second configuration information for a second radio bearer for the PDU session based on the second network entity being configured to support multiple radio bearers.

14. The first network entity of claim 13, wherein the first radio bearer is associated with one or more first quality of service (QOS) parameters, and wherein the second radio bearer is associated with one or more second QoS parameters.

15. The first network entity of claim 13, wherein the processing system is configured to transmit a second communication, wherein the second communication is associated with the second radio bearer based on filter information and one or more traffic parameters of the second communication.

16. The first network entity of claim 15, wherein the filter information is first filter information, and wherein the second configuration information indicates a filter state of the second radio bearer, wherein the filter state indicates:
second filter information for the second radio bearer, or
that no filters are configured for the second radio bearer.

17. The first network entity of claim 16, wherein the second filter information indicates a match-all filter for the second radio bearer.

18. The first network entity of claim 15, wherein the second radio bearer is associated with one or more traffic types, and wherein the filter information includes one or more filters configured for detection of the one or more traffic types.

19. The first network entity of claim 18, wherein the second communication is associated with the second radio bearer based on a match between the one or more traffic parameters and the one or more filters.

20. The first network entity of claim 18, wherein the processing system is configured to transmit an indication of the one or more traffic types.

21. The first network entity of claim 18, wherein the one or more filters include one or more traffic flow template filters.

22. The first network entity of claim 15, wherein the processing system is configured to:
provide a machine learning input that includes traffic flow information for previously communicated traffic; and
obtain a machine learning output that indicates the filter information, wherein the machine learning output is based on the machine learning input.

23. The first network entity of claim 22, wherein the machine learning input indicates one or more traffic types associated with the second radio bearer, and wherein the filter information includes one or more Internet protocol (IP) flows associated with the one or more traffic types.

24. The first network entity of claim 23, wherein the filter information includes one or more filters configured for detection of the one or more traffic types, and wherein the one or more filters are based on the one or more IP flows.

25. The first network entity of claim 15, wherein the processing system is configured to:
receive one or more third communications associated with the second radio bearer, wherein the one or more third communications are associated with the second network entity, and wherein the filter information is based on traffic flow information of the one or more third communication.

26. A method of wireless communication performed by a first network entity, comprising:
transmitting a first communication for establishment of a protocol data unit (PDU) session;
receiving, based on the first communication, first configuration information for a first radio bearer for the PDU session;
receiving, based on the first communication, second configuration information for a second radio bearer for the PDU session, wherein the second configuration information indicates a filter state of the second radio bearer, wherein the filter state indicates that first filter information is configured for the second radio bearer or that no filters are configured for the second radio bearer; and
transmitting a second communication, wherein the second communication is associated with the PDU session, and wherein the second communication is associated with the second radio bearer based on second filter information and one or more traffic parameters of the second communication.

27. The method of claim 26, wherein the second radio bearer is associated with one or more traffic types, and wherein the second filter information includes one or more filters configured for detection of the one or more traffic types.

28. The method of claim 27, wherein the second communication is associated with the second radio bearer based on a match between the one or more traffic parameters and the one or more filters.

29. A method of wireless communication performed by a first network entity, comprising:
receiving a first communication for establishment of a protocol data unit (PDU) session for a second network entity;
transmitting, based on the first communication, first configuration information for a first radio bearer for the PDU session; and
transmitting, based on the first communication, second configuration information for a second radio bearer for the PDU session based on the second network entity being configured to support multiple radio bearers.

30. The method of claim 29, further comprising transmitting a second communication, wherein the second communication is associated with the second radio bearer based on filter information and one or more traffic parameters of the second communication.
